(19) United States
(12) Patent Application Publication
(10) Pub. No.: US 2026/0349149 A1
(43) Pub. Date: Nov. 5, 2026

(54) MULTILAYER FILM, OPTICAL MEMBER, AND MULTILAYER FILM PRODUCTION METHOD

(71) Applicant: CANON OPTRON, INC., Ibaraki (JP)

(72) Inventor: TETSUYA MURATA, Ibaraki (JP)

(21) Appl. No.: 19/716,617

(22) Filed: Jun. 23, 2026

Related U.S. Application Data
(63) Continuation of application No. PCT/JP2024/043417, filed on Dec. 9, 2024.

(30) Foreign Application Priority Data
Dec. 27, 2023 (JP) 2023-221408

(51) Int. Cl. G02B 1/18; C03C 17/245; G02B 1/115

(52) U.S. Cl. CPC G02B 1/18; C03C 17/245; G02B 1/115; C03C 2217/71

(57) ABSTRACT

A multilayer film is provided that sufficiently exhibits a self-cleaning function through a photocatalytic reaction on a surface and maintains hydrophilicity in the dark for a long period even when a low-refractive-index surface layer has a thickness sufficient to reduce light reflectance. The multilayer film comprises a cerium oxide-containing layer and a low-refractive-index layer including a silicon oxide-containing layer or a magnesium fluoride-containing layer. The cerium oxide-containing layer contains cerium oxide having a cubic polycrystalline structure and a columnar structure, has a thickness of 85-800 nm, and has an oxygen deficiency rate (VA) of 0.05-10%. The low-refractive-index layer has a thickness of 50-240 nm and a refractive index of 1.65 or less for light having a wavelength of 500 nm.

### CROSS-REFERENCE TO RELATED APPLICATIONS

This application is a Continuation of International Patent Application No. PCT/JP2024/043417, filed Dec. 9, 2024, which claims the benefit of Japanese Patent Application No. 2023-221408, filed Dec. 27, 2023, both of which are hereby incorporated by reference herein in their entirety.

### BACKGROUND

### Field of the Technology

The present disclosure relates to a multilayer film excellent in self-cleaning property and hydrophilicity, an optical member including the multilayer film, and a method of producing the multilayer film.

### Description of the Related Art

An optical member, such as an optical lens, a mirror, or an optical filter, has a film formed of an inorganic material in order to increase or reduce the transmittance and reflectance of light. The film formed of an inorganic material generally has high surface free energy and hence has high hydrophilicity immediately after film formation. However, through a self-reaction or the adhesion of dirt derived from a human or an environment, the surface free energy is reduced and hence the hydrophilicity is reduced in a relatively short time period.

For example, when the adhesion of water droplets occurs under a state in which the hydrophilicity of the surface of an optical product to be used in an automobile, an optical product to be used outdoors, such as a security camera or an eyeglass lens, or a protective cover therefor is decreased, visibility may deteriorate, and hence there is a risk in that the functions of the above-mentioned optical products and protective covers cannot be sufficiently exhibited.

As means for solving the above-mentioned problem, a hydrophilic film in which a silicon dioxide thin film is formed on a crystalline titanium dioxide thin film is used (Japanese Patent Laid-Open No. 2000-053449, Japanese Patent Laid-Open No. H09-057912, and K. Miyashita, et al, Journal of the Ceramic Society of Japan 110 [5]450-454 (2002)). When the surface of crystalline titanium dioxide is irradiated with near-ultraviolet light, active oxygen is produced through a photocatalytic function, and the produced active oxygen decomposes an organic substance on the surface of the hydrophilic film. As a result, the hydrophilicity of the hydrophilic film is restored, and dirt is washed away by rainfall. Thus, the hydrophilic film is self-cleaned. In addition, it has been known that, when silicon dioxide is arranged on titanium dioxide, the resultant thin film is not hydrophobized in a short time period unlike the thin film formed of only titanium dioxide even when light irradiation is stopped, and the hydrophilicity persists for from about 1 week to about 2 weeks even in the dark.

However, as described in Table 2 of Japanese Patent Laid-Open No. 2000-053449, when the thickness of the silicon dioxide thin film formed on the crystalline titanium dioxide thin film is less than 50 nm, there is a problem in that the reflectance is increased and the transmittance is reduced because titanium dioxide has a large refractive index. Accordingly, there is a problem in that, although such hydrophilic film may be applied to an in-vehicle door mirror in which no problem occurs even when the reflectance is increased, the hydrophilic film is not suitable for an optical member such as a lens including an antireflection film.

In addition, when the thickness of the silicon dioxide thin film on the surface formed on the crystalline titanium dioxide thin film is 50 nm or more, there is a problem in that the self-cleaning function through a photocatalytic reaction is not sufficiently exhibited. In addition, there is a problem in that, although the hydrophilicity-maintaining performance in the dark is improved as compared to the case of only the crystalline titanium dioxide, the hydrophilicity-maintaining performance is not sufficient.

In addition, as described in each of Examples of Japanese Patent Laid-Open No. H09-057912, and K. Miyashita, et al, Journal of the Ceramic Society of Japan 110 [5]450-454 (2002), when the crystalline titanium dioxide layer is used as a photocatalyst, there is a problem in that, in order to crystallize a thin film formed of titanium dioxide, the thin film and a base material on which the thin film is arranged may be required to be heated to high temperature, with the result that a base material formed of a resin having low heat resistance cannot be used. The film formation of titanium dioxide by some wet processes does not require heating at high temperature. However, when a wet process is used, there are such inherent problems as described below: it is difficult to perform fine thickness control in units of 1 nm, the formation of a thin film having a uniform thickness, and film formation onto a base material except a base material having a simple shape, such as a flat plate; and the storage period of a coating liquid is short.

In consideration of application to an optical member, even when the thickness of a low-refractive-index layer on the surface of the optical member is set to be large so that the low-refractive-index layer can be designed as an antireflection film, there has been a demand for a multilayer film that sufficiently exhibits a self-cleaning function through a photocatalytic reaction. In addition, there has been a demand for a multilayer film that maintains hydrophilicity in the dark for a longer time period.

The present disclosure has been made in view of the above-mentioned problems, and is directed to providing a multilayer film, which sufficiently exhibits a self-cleaning function through a photocatalytic reaction on a surface, and can maintain hydrophilicity in the dark for a long time period, even when the thickness of a low-refractive-index layer on the surface is set to a specific thickness or more in order to reduce the reflectance of light. The present disclosure is also directed to providing an optical member including the above-mentioned multilayer film. The present disclosure is also directed to providing a method of producing the above-mentioned multilayer film.

### SUMMARY

In order to solve the above-mentioned problems, the present disclosure is directed to a multilayer film including: a layer containing cerium oxide; and a low-refractive-index layer formed on the layer containing cerium oxide directly or through intermediation of another layer, wherein the low-refractive-index layer includes a layer containing silicon oxide or a layer containing magnesium fluoride, wherein the layer containing cerium oxide contains cerium oxide having a cubic polycrystalline structure and a columnar structure, wherein the layer containing cerium oxide has a thickness of 85 nm or more and 800 nm or less, wherein, when an entirety of the layer containing cerium oxide is represented by a region (A) and an oxygen deficiency rate of cerium oxide in the region (A) is represented by an oxygen deficiency rate (V_{A}), the oxygen deficiency rate (V_{A}) is 0.05% or more and 10% or less, wherein the low-refractive-index layer has a thickness of 50 nm or more and 240 nm or less, and wherein the low-refractive-index layer has a refractive index of 1.65 or less with respect to light having a wavelength of 500 nm.

In addition, the present disclosure is directed to an optical member including the above-mentioned multilayer film.

In addition, the present disclosure is directed to a method of producing a multilayer film, the method including: a step (A) of forming a layer containing cerium oxide on a base material directly or through intermediation of another layer by a vacuum vapor deposition method; and a step (B) of forming a low-refractive-index layer on the layer containing cerium oxide directly or through intermediation of another layer by the vacuum vapor deposition method, wherein the low-refractive-index layer includes a layer containing silicon oxide or a layer containing magnesium fluoride, wherein the layer containing cerium oxide contains cerium oxide having a cubic polycrystalline structure and a columnar structure, wherein the layer containing cerium oxide has a thickness of 85 nm or more and 800 nm or less, wherein, when an entirety of the layer containing cerium oxide is represented by a region (A) and an oxygen deficiency rate of cerium oxide in the region (A) is represented by an oxygen deficiency rate (V_{A}), the oxygen deficiency rate (V_{A}) is 0.05% or more and 10% or less, and wherein the low-refractive-index layer has a thickness of 50 nm or more and 240 nm or less.

According to one aspect of the present disclosure, the multilayer film, which sufficiently exhibits a self-cleaning function through a photocatalytic reaction on a surface, and can maintain hydrophilicity even in the dark for a long time period, even when the thickness of the low-refractive-index layer on the surface is set to a specific thickness or more in order to reduce the reflectance of light, the optical member including the multilayer film, and the method of producing the multilayer film can be obtained.

Features of the present disclosure will become apparent from the following description of embodiments with reference to the attached drawings.

### BRIEF DESCRIPTION OF THE DRAWINGS

FIG. 1A is a schematic sectional view for illustrating a configuration according to a first embodiment of the present disclosure.

FIG. 1B is a schematic sectional view for describing the first embodiment of the present disclosure.

FIG. 2 is a schematic sectional view for illustrating a configuration according to a second embodiment of the present disclosure.

FIG. 3 is a schematic view for illustrating an example of an application example according to the present disclosure.

FIG. 4 is a schematic view for illustrating another example of the application example according to the present disclosure.

### DESCRIPTION OF THE EMBODIMENTS

Embodiments of a multilayer film, an optical member including the multilayer film, and a method of forming the multilayer film according to the present disclosure are described below by way of preferred embodiments.

In addition, the present disclosure is not limited to the following embodiments.

In addition, in the present disclosure, the description [XX or more and YY or less] or [XX to YY] representing a numerical range means a numerical range including a lower limit and an upper limit that are end points unless otherwise stated. Further, when the numerical ranges are described in stages, the upper limit and lower limit of each numerical range may be freely combined.

In the present disclosure, the term [multilayer film] refers to a configuration including two or more layers formed on the surface of a base material. The multilayer film according to the present disclosure may be arranged on the base material directly or through intermediation of another layer. The layers for forming the multilayer film may be hereinafter also referred to as “film” or “thin film.”

In the present disclosure, the term [base material] refers to a solid material as an article.

In the present disclosure, the term [optical member] refers to an optical member including the above-mentioned multilayer film. Examples of the optical member include an optical filter, an optical lens, a daylighting lens, an optical film, an optical prism, an eyeglass lens, a photographic lens, a surveillance camera cover, an in-vehicle camera cover, an in-vehicle sensor cover, a vehicle door mirror, a platform screen door sensor, a daylighting lens cover, a glass sheet, a condenser lens, a display cover glass, a touch panel, and various kinds of films.

Prior to the specific description of the multilayer film according to the present disclosure, for the purpose of understanding the present disclosure, first, the estimation of a mechanism by which effects thereof are exhibited is described below. However, the following description is merely a hypothesis, and the present disclosure is not limited by the following hypothesis in any way.

The inventor has found that, when a layer containing cerium oxide having a cubic polycrystalline structure having a specific oxygen vacancy is arranged on a base material directly or through intermediation of another layer, and further, a layer containing magnesium fluoride or silicon oxide having a specific thickness is arranged on the above-mentioned layer containing cerium oxide directly or through intermediation of another layer, a hydrophilicity recovery function through a self-cleaning property with a photocatalyst is exhibited and a hydrophilicity-maintaining ability in the dark is significantly improved. Regarding the above-mentioned mechanism, the following contents are conceived.

When a photocatalyst film that responds to near-ultraviolet light is irradiated with near-ultraviolet light, electrons and holes are generated by photoexcitation. When the generated electrons and holes can reach the surface of the film, a chemical reaction occurs, and hence the hydrophilicity recovery function through a self-cleaning property is exhibited. An appropriate amount of oxygen vacancies are present in cerium oxide of the layer containing cerium oxide of the present disclosure. The recombination of holes and electrons generated by photoexcitation is suppressed because the oxygen vacancies are not excessive. As a result, photocatalytic activity becomes strong. In addition, a reduction in mobility of each of electrons and holes generated by photoexcitation caused by the shortage of oxygen vacancies is suppressed. As a result, a reduction in self-cleaning function with a photocatalyst is suppressed.

Further, when the oxygen vacancies are present, the oxygen vacancies capture water molecules (H₂O), oxygen molecules (O₂), and the like derived from a thin film and an environment, and active species are produced even in an environment without ultraviolet light, contributing to maintaining the hydrophilicity of the surface in the dark. In addition, in the layer containing cerium oxide of the present disclosure, an oxygen vacancy is present particularly at a polycrystalline interface. Thus, electrical conductivity is improved, and hence the separation of electrons and holes generated by photoexcitation is promoted, and the electrons and the holes are smoothly moved along the interface and easily reach the surface. As a result of the foregoing, it is conceived that a hydrophilicity recovery function through a self-cleaning property with a photocatalyst is exhibited and a hydrophilicity-maintaining ability in the dark is significantly improved.

### First Embodiment

A first embodiment is directed to a multilayer film.

The multilayer film of the present disclosure includes: a layer containing cerium oxide; and a low-refractive-index layer formed on the layer containing cerium oxide directly or through intermediation of another layer, wherein the low-refractive-index layer includes a layer containing silicon oxide or a layer containing magnesium fluoride, wherein the layer containing cerium oxide contains cerium oxide having a cubic polycrystalline structure and a columnar structure, wherein the layer containing cerium oxide has a thickness of 85 nm or more and 800 nm or less, wherein, when the entirety of the layer containing cerium oxide is represented by a region (A) and the oxygen deficiency rate of cerium oxide in the region (A) is represented by an oxygen deficiency rate (V_{A}), the oxygen deficiency rate (V_{A}) is 0.05% or more and 10% or less, wherein the low-refractive-index layer has a thickness of 50 nm or more and 240 nm or less, and wherein the low-refractive-index layer has a refractive index of 1.65 or less with respect to light having a wavelength of 500 nm.

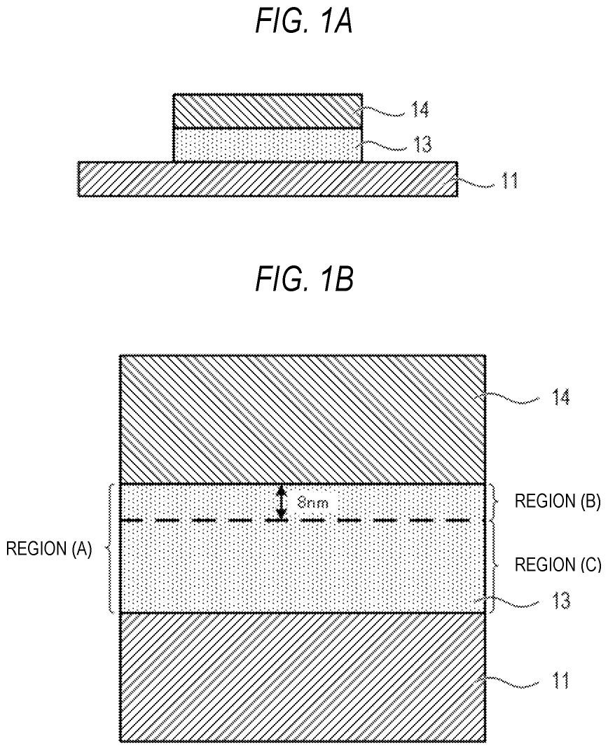

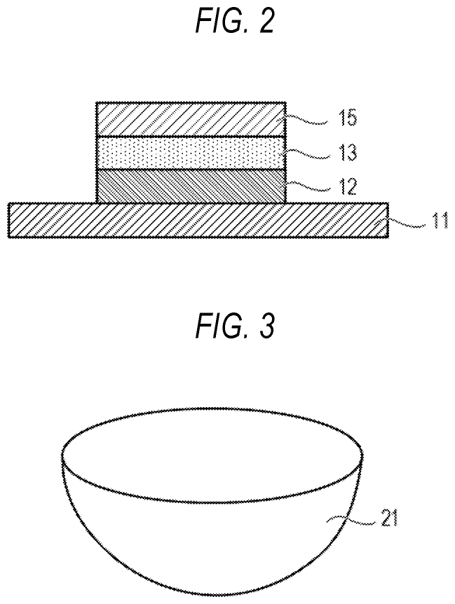

The multilayer film of the present disclosure includes a layer containing cerium oxide, and a low-refractive-index layer formed on the layer containing cerium oxide directly or through intermediation of another layer, and the low-refractive-index layer includes a layer containing silicon oxide or a layer containing magnesium fluoride. FIG. 1A is a schematic sectional view for illustrating a multilayer film according to a first embodiment of the present disclosure arranged on a base material. FIG. 1A is an illustration of a configuration example in which a layer 13 containing cerium oxide of the present disclosure is formed on a base material 11, and further, a layer 14 containing magnesium fluoride is formed as a low-refractive-index layer on the layer 13 containing cerium oxide. In FIG. 1A (and FIG. 1B described later), a layer 15 containing silicon oxide may be formed on the layer 13 containing cerium oxide as an alternative to the layer 14 containing magnesium fluoride. In each of FIG. 1A, FIG. 1B, and FIG. 2, the configuration of the multilayer film in the present disclosure is schematically illustrated. Accordingly, the area, thickness, and the like of each of the layers are not illustrated in accurate proportions.

The base material 11 is described.

It is only required that the base material 11 enable another layer 12 or the layer 13 containing cerium oxide of the present disclosure to be laminated thereon, and glass, a ceramic, a resin, a metal, or the like may be used. The shape of the base material is not limited, and the base material may have, for example, a flat surface shape, a curved surface shape, a concave surface shape, a convex surface shape, or a film shape. In addition, the base material 11 may include a hard coat layer or a barrier layer. In addition, the size and thickness of the base material 11 are not particularly limited, and may be appropriately set in accordance with applications and the like.

The layer 13 containing cerium oxide according to the present disclosure is described. In the multilayer film of the present disclosure, when the entirety of the layer containing cerium oxide is represented by a region (A) and the oxygen deficiency rate of cerium oxide in the region (A) is represented by an oxygen deficiency rate (V_{A}), the oxygen deficiency rate (V_{A}) is 0.05% or more and 10% or less. When the oxygen deficiency rate is less than 0.05%, the mobility of each of electrons and holes excited by light is reduced, and a self-cleaning function with a photocatalyst is reduced. When the oxygen deficiency rate is more than 10%, electrons and holes excited by light easily recombine, and hence the self-cleaning function with a photocatalyst is reduced.

The term [oxygen deficiency rate] as defined in the present disclosure means that, when the oxygen content of cerium oxide is represented by A and the theoretical oxygen content of CeO₂ is represented by B, the oxygen deficiency rate may be represented by (B−A)/B×100(%). For example, the oxygen deficiency rate of CeO₂ in accordance with stoichiometric composition is 0%, and the oxygen deficiency rate when it is assumed that all oxygen atoms of CeO₂ are absent (when Ce is assumed) is 100%.

In the multilayer film of the present disclosure, the oxygen deficiency rate (V_{A}) of cerium oxide in the region (A) of the layer 13 containing cerium oxide is preferably 0.05% or more and 0.6% or less. When the oxygen deficiency rate is 0.05% or more, a self-cleaning ability and a hydrophilicity-maintaining ability are further enhanced.

In the multilayer film of the present disclosure, the oxygen deficiency rate (V_{A}) of cerium oxide in the region (A) of the layer 13 containing cerium oxide is more preferably 0.1% or more and 0.3% or less. When the oxygen deficiency rate falls within the above-mentioned range, the self-cleaning ability and the hydrophilicity-maintaining ability are further enhanced.

In the multilayer film of the present disclosure, the layer 13 containing cerium oxide contains cerium oxide (CeOₓ) having a cubic polycrystalline structure. In a layer formed of cerium oxide having a single crystalline structure, cracks are liable to occur in the film. In a layer formed of cerium oxide having an amorphous structure, the self-cleaning function with a photocatalyst and the hydrophilicity-maintaining ability in the dark are significantly reduced.

In addition, the term [polycrystalline structure] as defined in the present disclosure means that a peak unique to cerium oxide appears in the X-ray diffraction (XRD) measurement of a film after film formation.

In the multilayer film of the present disclosure, the layer 13 containing cerium oxide has a thickness of 85 nm or more and 800 nm or less. When the thickness of the layer 13 containing cerium oxide is less than 85 nm, the self-cleaning function with a photocatalyst and the hydrophilicity-maintaining ability in the dark are significantly reduced. In addition, when the thickness of the layer 13 containing cerium oxide is more than 800 nm, cracks are liable to occur, and light scattering due to heterogeneity, surface roughness, and grain boundaries of polycrystals may become too large. The cracks and the light scattering may adversely affect optical characteristics.

In the multilayer film of the present disclosure, the layer 13 containing cerium oxide contains cerium oxide having a columnar structure. When cerium oxide has a columnar structure, the separation of electrons and holes excited by light is promoted, and the electrons and vacancies easily reach a surface. Thus, the self-cleaning function with a photocatalyst is further enhanced.

Herein, the term [columnar structure] in the present disclosure is defined. The columnar structure means that a polycrystal having, for example, a cylindrical structure, a prismatic structure, a frustum structure, a rod-like structure, or a fibrous columnar shape is included in the film. The columnar structure may be solid or hollow. The columnar structure generally grows in the longitudinal direction from the base material side of the film toward the outside air side of the film, and includes those extending straight in a vertical direction, those extending in an inclined shape, those extending while curving, those extending while branching into a branch shape, those fused in the middle of growth of a plurality of columnar crystals, and the like.

The layer 13 containing cerium oxide of the present disclosure may be arranged directly on the base material 11 or may be arranged thereon through intermediation of the another layer 12 described later.

In the multilayer film of the present disclosure, the low-refractive-index layer has a thickness of 50 nm or more and 240 nm or less. In the multilayer film of the present disclosure, the refractive index of the low-refractive-index layer is 1.65 or less, preferably 1.60 or less, more preferably 1.55 or less, still more preferably 1.52 or less with respect to light having a wavelength of 500 nm. In the multilayer film of the present disclosure, the refractive index of the low-refractive-index layer is preferably 1.35 or more, more preferably 1.38 or more with respect to light having a wavelength of 500 nm.

The layer 14 containing magnesium fluoride according to the present disclosure is described. In the multilayer film of the present disclosure, the thickness of the layer 14 containing magnesium fluoride is 50 nm or more and 240 nm or less. When the thickness of the layer 14 containing magnesium fluoride is less than 50 nm, the reflectance of the multilayer film may become too high. Meanwhile, when the thickness of the layer 14 containing magnesium fluoride is more than 240 nm, the self-cleaning function with a photocatalyst is not exhibited on the surface of the multilayer film in some cases. In addition, in the multilayer film of the present disclosure, the refractive index of the layer 14 containing magnesium fluoride is 1.65 or less, preferably 1.60 or less, more preferably 1.55 or less, still more preferably 1.52 or less with respect to light having a wavelength of 500 nm. In the multilayer film of the present disclosure, the refractive index of the layer 14 containing magnesium fluoride is preferably 1.35 or more, more preferably 1.38 or more with respect to light having a wavelength of 500 nm. When the refractive index of the layer 14 containing magnesium fluoride is more than 1.65, the reflectance of the multilayer film may become too high.

In the multilayer film of the present disclosure, as illustrated in FIG. 1B, when the region of the layer 13 containing cerium oxide positioned within 8 nm from an interface between the layer 13 containing cerium oxide and the layer 14 containing magnesium fluoride is represented by a region (B), and the oxygen deficiency rate of cerium oxide in the region (B) is represented by an oxygen deficiency rate (V_{B}), the oxygen deficiency rate (V_{B}) is preferably 0.5% or more and 30% or less. In the multilayer film of the present disclosure, when a region excluding the region (B) in the region (A) is represented by a region (C) and the oxygen deficiency rate of cerium oxide in the region (C) is represented by an oxygen deficiency rate (V_{C}), the oxygen deficiency rate (V_{C}) is preferably 0% or more and 10% or less. In the multilayer film of the present disclosure, the oxygen deficiency rate (V_{B}) is preferably larger than the oxygen deficiency rate (V_{C}).

The content ratio of magnesium fluoride in the total amount of substances for forming the layer 14 containing magnesium fluoride is preferably 65 mass % or more. When the content ratio falls within the above-mentioned range, the hydrophilicity-maintaining ability in the dark is further enhanced.

As described above, in FIG. 1A and FIG. 1B, the layer 15 containing silicon oxide may be arranged instead of the layer 14 containing magnesium fluoride. The layer 15 containing silicon oxide according to the present disclosure is described below.

In the multilayer film of the present disclosure, the refractive index of the layer 15 containing silicon oxide is 1.65 or less, preferably 1.60 or less, more preferably 1.55 or less, still more preferably 1.52 or less with respect to light having a wavelength of 500 nm. In the multilayer film of the present disclosure, the refractive index of the layer 14 containing silicon oxide is preferably 1.35 or more, more preferably 1.38 or more with respect to light having a wavelength of 500 nm. When the refractive index of the layer 15 containing silicon oxide is more than 1.65, the reflectance of the multilayer film may become too high. In the multilayer film of the present disclosure, the thickness of the layer 15 containing silicon oxide is 50 nm or more and 240 nm or less. When the thickness of the layer 15 containing silicon oxide is less than 50 nm, the reflectance of the multilayer film may become too high. Meanwhile, when the thickness of the layer 15 containing silicon oxide is more than 240 nm, the self-cleaning function with a photocatalyst is not exhibited on the surface of the multilayer film in some cases.

In the multilayer film of the present disclosure, as illustrated in FIG. 1B, when the region of the layer 13 containing cerium oxide positioned within 8 nm from an interface between the layer 13 containing cerium oxide and the layer 15 containing silicon oxide is represented by a region (B), and the oxygen deficiency rate of cerium oxide in the region (B) is represented by an oxygen deficiency rate (V_{B}), the oxygen deficiency rate (V_{B}) is preferably 0.5% or more and 30% or less. In the multilayer film of the present disclosure, when a region excluding the region (B) in the region (A) is represented by a region (C) and the oxygen deficiency rate of cerium oxide in the region (C) is represented by an oxygen deficiency rate (V_{C}), the oxygen deficiency rate (V_{C}) is preferably 0% or more and 10% or less. In the multilayer film of the present disclosure, the oxygen deficiency rate (V_{B}) is preferably larger than the oxygen deficiency rate (V_{C}).

The layer 15 containing silicon oxide is a layer containing silicon oxide (SiOₓ). The content ratio of silicon oxide in the layer 15 containing silicon oxide is preferably 65 mass % or more with respect to the entirety of the layer 15 containing silicon oxide. When the content ratio of silicon oxide in the layer 15 containing silicon oxide falls within the above-mentioned range, the hydrophilicity-maintaining ability in the dark is further enhanced.

In the layer 15 containing silicon oxide, the composition of silicon oxide is SiOₓ, and “x” represents preferably 1.5 or more and 2.0 or less. When the value of “x” in the composition SiOₓ of silicon oxide falls within the above-mentioned range, the refractive index of the layer 15 containing silicon oxide can be set to 1.65 or less. In addition, a more transparent film can be obtained in the wavelength range of from visible light to near-infrared light.

The layer 15 containing silicon oxide may contain aluminum oxide in addition to silicon oxide (SiOₓ). In this case, the content ratio of aluminum oxide in the layer 15 containing silicon oxide is preferably 0.1 mass % or more and 10 mass % or less with respect to the entirety of the layer 15 containing silicon oxide. When the layer 15 containing silicon oxide contains 0.1 mass % to 10 mass % of aluminum oxide, the durability of the multilayer film, such as scratch resistance and moisture resistance, can be enhanced while the self-cleaning function with a photocatalyst and hydrophilicity-maintaining ability in the dark of the multilayer film are kept.

The layer 15 containing silicon oxide may contain cerium oxide in addition to silicon oxide (SiOₓ). In this case, the content ratio of cerium oxide in the layer 15 containing silicon oxide is preferably 0.1 mass % or more and 10 mass % or less with respect to the entirety of the layer 15 containing silicon oxide. When the layer 15 containing silicon oxide contains 0.1 mass % to 10 mass % of cerium oxide, the self-cleaning function with a photocatalyst can be enhanced while the hydrophilicity-maintaining ability of the multilayer film is kept.

### Second Embodiment

A second embodiment is directed to a multilayer film.

The multilayer film of the second embodiment is different from the multilayer film of the first embodiment in that the multilayer film is arranged on the another layer 12 arranged on the base material 11. Configurations except the another layer 12 are as described above, and hence description thereof is omitted.

FIG. 2 is a schematic sectional view for illustrating a multilayer film according to a second embodiment of the present disclosure. In FIG. 2, the multilayer film according to the present disclosure is arranged on the another layer 12 arranged on the base material 11. That is, in the second embodiment, there is illustrated a configuration example in which the another layer 12 is formed on the base material 11, further, the layer 13 containing cerium oxide of the present disclosure is formed on the another layer 12, and in addition, the layer 15 containing silicon oxide is formed as a low-refractive-index layer on the layer 13 containing cerium oxide.

The base material 11 and the layer 13 containing cerium oxide of the present disclosure are as described in the above-mentioned first embodiment.

In FIG. 2, the layer 14 containing magnesium fluoride described in the first embodiment may be arranged instead of the entirety or part of the layer 15 containing silicon oxide. In addition, the layer 13 containing cerium oxide of the present disclosure may be arranged directly on the base material 11 without intermediation of the another layer 12.

A layer containing a metal, a fluoride, an oxide, a carbide, a sulfide, a halide, a nitride, or a complex anion compound (e.g., an oxynitride, an oxysulfide, an oxyhalide, an oxyfluoride, or an oxynitride) may be arranged as the another layer 12. Specifically, for example, a metal layer containing an element, such as aluminum (Al), chromium (Cr), gold (Au), silver (Ag), copper (Cu), silicon (Si), germanium (Ge), titanium (Ti), or nickel (Ni), a layer containing a fluoride, such as magnesium fluoride (MgF₂) or calcium fluoride (CaF₂), a layer containing an oxide, such as silicon oxide (SiOₓ), aluminum oxide (Al₂Oₓ), yttrium oxide (Y₂Oₓ), zirconium oxide (ZrOₓ), hafnium oxide (HfOₓ), zinc oxide (ZnOₓ), tantalum oxide (Ta₂Oₓ), niobium oxide (Nb₂Oₓ), indium oxide (In₂Oₓ), tin oxide (SnOₓ), tungsten oxide (WOₓ), cerium oxide (CeOₓ), titanium oxide (TiOₓ), lanthanum titanate (LaₓTi_{y}Oz), aluminum titanate (LaₓAl_{y}Oz), or alumina-added silicon dioxide (SiO₂+Al₂O₃), a layer containing a sulfide such as ZnS, a layer containing a nitride, such as silicon nitride (SiₓN_{y}) or gallium nitride (GaN), a layer containing a carbide such as tungsten carbide (WC), or a complex anion compound, such as silicon oxynitride (SiOₓN_{y}) or lead titanium oxyfluoride (Pb_{w}TiₓO_{y}F_{z}), may be used as the another layer 12. The another layer 12 may be one layer, or a multilayer of two or more layers. When the another layer 12 is a multilayer of two or more layers, the another layer 12 may be formed of a combination of a plurality of kinds of layers out of the layers listed above. In addition, the another layer 12 may be a layer containing a mixture formed of two or more kinds of the compounds in the layers listed above.

A method of forming the another layer 12 is not particularly limited. As the method of forming the another layer 12, for example, a dry film forming method, such as a sputtering method, a vacuum vapor deposition method, or an ion plating method, or a wet film forming method, such as a dipping method, a coating method, a spraying method, a spin coating method, a bar coating method, a printing method, or a flow coating method, may be applied.

When the composition, refractive index, thickness, number of layers, and the like of the another layer 12 are set in accordance with purposes and functions, a multilayer film having imparted thereto a specific function, such as an antireflection layer, a half mirror layer, a light-absorbing layer, an alkali diffusion-preventing layer, an adhesion layer, an antistatic layer, or a heater layer, can be formed.

### Application Example

An application example of the present disclosure is directed to an optical member.

The optical member of the present disclosure is characterized by including the above-mentioned multilayer film.

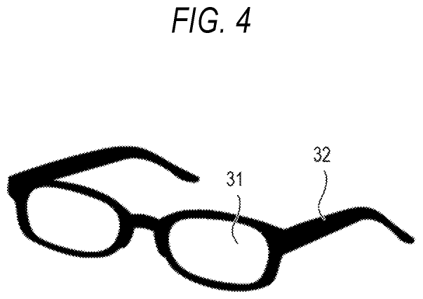

FIG. 3 and FIG. 4 are each a schematic view for illustrating the configuration of an optical member according to one embodiment of the present disclosure. FIG. 3 is an illustration of a lens cover for a surveillance camera in which the multilayer film of the present disclosure is formed on the surface of a dome-shaped resin base material 21. In addition, FIG. 4 is an illustration of a pair of eyeglasses including: eyeglass lenses 31 that are each the optical member according to one embodiment of the present disclosure; and an eyeglass frame 32. The multilayer film of the present disclosure is formed on each of both the surfaces of the eyeglass lens 31.

The multilayer film of the present disclosure may be used as an optical thin film, such as an antireflection film, various kinds of optical filter multilayer films, or an optical mirror multilayer film. In addition, the multilayer film of the present disclosure may be used in, for example, optical members, such as an optical filter, an optical lens, a daylighting lens, an optical film, an optical prism, an eyeglass lens, a photographic lens, a surveillance camera cover, an in-vehicle camera cover, an in-vehicle sensor cover, a vehicle door mirror, a glass sheet, a condenser lens, a display cover glass, a touch panel, and various kinds of films, or covers for protecting the optical members. In addition, when the surface of the base material 11 except the surface on which the above-mentioned layers are arranged is coated with a layer having the composition, refractive index, thickness, number of layers, and the like in accordance with purposes and functions, the multilayer film can be formed as an optical member having imparted thereto a specific function, such as a mirror layer, a half mirror layer, a light-absorbing layer, a transparent heater layer, or an antireflection layer.

### Third Embodiment

A third embodiment is directed to a method of producing a multilayer film.

The method of producing a multilayer film of the present disclosure includes: a step (A) of forming a layer containing cerium oxide on a base material directly or through intermediation of another layer by a vacuum vapor deposition method; and a step (B) of forming a low-refractive-index layer on the layer containing cerium oxide directly or through intermediation of another layer by the vacuum vapor deposition method, wherein the low-refractive-index layer includes a layer containing silicon oxide or a layer containing magnesium fluoride, wherein the layer containing cerium oxide contains cerium oxide having a cubic polycrystalline structure and a columnar structure, wherein the layer containing cerium oxide has a thickness of 85 nm or more and 800 nm or less, wherein, when the entirety of the layer containing cerium oxide is represented by a region (A) and the oxygen deficiency rate of cerium oxide in the region (A) is represented by an oxygen deficiency rate (V_{A}), the oxygen deficiency rate (V_{A}) is 0.05% or more and 10% or less, and wherein the low-refractive-index layer has a thickness of 50 nm or more and 240 nm or less.

Description is given below. The multilayer film is as described above, and hence part of the description is omitted.

The layer 13 containing cerium oxide formed in the above-mentioned step (A) contains cerium oxide having a cubic polycrystalline structure having a specific oxygen deficiency rate, and the thickness of the layer 13 containing cerium oxide formed in the above-mentioned step (A) is 85 nm or more and 800 nm or less. In addition, the thickness of the layer 15 containing silicon oxide or the layer 14 containing magnesium fluoride formed in the above-mentioned step (B) is 50 nm or more and 240 nm or less. The refractive index of each of the layer 15 containing silicon oxide and the layer 14 containing magnesium fluoride formed in the above-mentioned step (B) is 1.65 or less with respect to light having a wavelength of 500 nm.

The method of producing a multilayer film of the present disclosure includes: a step (A) of forming a layer containing cerium oxide on a base material directly or through intermediation of another layer by a vacuum vapor deposition method; and a step (B) of forming a layer containing silicon oxide or a layer containing magnesium fluoride on the layer containing cerium oxide directly or through intermediation of another layer by the vacuum vapor deposition method. The temperature of the base material when vacuum vapor deposition is performed is preferably a temperature at which cerium oxide is crystallized. Although depending on the heat-resistant temperature of a base material to be used and other film forming conditions, the temperature may be typically selected in the range of 0 °C or more and 500 °C or less.

An evaporation method in the vacuum vapor deposition is not limited as long as the evaporation method is a method in which a film forming material is evaporated. For example, as the evaporation method, evaporation means, such as an electron gun, resistance heating, or a laser, may be applied. In addition, ion-assisted deposition, plasma-assisted deposition, or the like may be used in combination with the above-mentioned evaporation means as required.

In the method of producing a multilayer film of the present disclosure, prior to the step (A), the total value of the partial pressure of water molecules (H₂O) and the partial pressure of oxygen molecules (O₂) in an atmosphere in advance is preferably 2×10⁻² Pa or less, more preferably 5.9×10⁻⁴ Pa or less. In addition, the total value of the partial pressure of water molecules (H₂O) and the partial pressure of oxygen species (in the present disclosure, the term “oxygen species” refers to an oxygen atom, an oxygen molecule, and an oxygen ion) during the film formation of the region (B) is preferably 2×10⁻² Pa or less on average, more preferably 7.8×10⁻³ Pa or less on average.

Even in the case where the degree of vacuum in the vapor deposition apparatus is the same (e.g., the degree of vacuum is 7×10⁻⁴ Pa), the partial pressure ratio of a gas remaining in a vacuum atmosphere greatly changes when states in the vapor deposition apparatus are different, for example, depending on the degree of dirt, whether there is a minute vacuum leakage or there is almost no leakage, or the implementation of preliminary baking. As a result, the characteristics of the resultant layer 13 containing cerium oxide may be affected because a gas partial pressure before and during the film formation of the layer containing cerium oxide changes. For example, the partial pressure of water molecules may be reduced by performing cleaning so that an adsorbed substance (e.g., a water molecule) around an evaporation source, on a wall surface, or the like in the apparatus is reduced before film formation.

In addition, regarding the film forming material for film formation with an electron gun, when the most commonly used hearth liner made of pure copper is used, an energy loss is large owing to high heat and electrical conductivity, and the temperature around the evaporation source becomes higher because the material does not evaporate unless an electron gun output is further increased. Accordingly, the amount of a desorbed adsorbed gas (e.g., a water molecule) may become larger. When a hearth liner made of molybdenum or tantalum is used instead of pure copper, the electron gun output during film formation can be reduced. In addition, molybdenum or the like has such a feature that a gas content is smaller than that of typical oxygen-free copper.

When a cryochiller is installed in a vacuum evacuation apparatus in addition to a rotary pump and a diffusion pump, the partial pressure of water molecules in an atmosphere is easily reduced. In addition, when, for example, the vicinity of the wall surface of the vacuum vapor deposition apparatus is heated with a heater (wall heater) that heats the wall surface of the vacuum vapor deposition apparatus, or baking is performed in advance, the partial pressure of water molecules in the atmosphere is easily reduced.

When it is recognized that there is almost no leakage in the film forming apparatus before the start of a film formation process, an oxygen partial pressure in the apparatus can be stabilized. This is because the characteristics of the layer containing cerium oxide to be obtained may be affected because the oxygen partial pressure in the atmosphere increases owing to air around the apparatus flowing into the apparatus even with a minute leakage.

When the base material is heated, there is a time lag until the actual temperature of the base material becomes the same as a temperature measured with a thermocouple. Although depending on a set temperature for heating the base material, a material for a base material holder, the thickness of the base material, and the like, it is required to wait for about 10 minutes to about 20 minutes after the temperature of the thermocouple has reached the set temperature. In addition, a considerable amount of moisture or the like is adsorbed to the base material, and hence when a substrate is sufficiently heated, a larger amount of moisture adsorbed to the base material before film formation can be desorbed. During the film formation, moisture is more easily desorbed from the base material because energy by radiant heat from the evaporation source is added. Accordingly, when the substrate was heated, the film formation process was started after the lapse of 15 minutes or more from the time when the thermocouple for measuring a substrate temperature indicated the set temperature±2 °C.

When the base material is installed in the vapor deposition apparatus, the base material is typically set in the apparatus with a jig called a holder, a mounting fixture, or the like. Regarding the jig, the emission amount of a gas such as moisture desorbed during film formation can be reduced when a washed and clean jig is used and a material with less gas adsorption and desorption such as SUS316LN is used. Meanwhile, a gas component, such as moisture or oxygen, is liable to be desorbed from the jig during film formation because, for example, a jig with dirt, a porous material, a jig whose material is brass or a synthetic resin, or a galvanized jig has a large gas emission amount.

The reason why the cleaning of the inner wall surface, the installation of the cryochiller, the recognition of leakage, the control of the substrate heating time, the selection of the jig material, and the like are performed as described above is that, when the layer 13 containing cerium oxide is formed, partial pressures of oxygen molecules and water molecules in the atmosphere are different even under the same gas introduction condition (e.g., when no gas is introduced at all or when the oxygen introduction amount is set to 1×10⁻² Pa). Accordingly, the oxygen deficiency rate of the layer containing cerium oxide to be obtained may be affected. Accordingly, when those processes are not performed, a multilayer film including the layer 13 containing cerium oxide of the present disclosure is not obtained in some cases even when other film forming conditions and the like are the same as those of Examples of the present application.

In the method of producing a multilayer film of the present disclosure, when the entirety of the layer containing cerium oxide is represented by a region (A) and the oxygen deficiency rate of cerium oxide in the region (A) is represented by an oxygen deficiency rate (V_{A}), the oxygen deficiency rate (V_{A}) is 0.05% or more and 10% or less. In addition, in the method of producing a multilayer film of the present disclosure, as illustrated in FIG. 1B, it is preferred that: when the region of the layer containing cerium oxide positioned within 8 nm from an interface between the layer containing cerium oxide and the low-refractive-index layer (the layer containing magnesium fluoride or the layer containing silicon oxide) is represented by a region (B), and the oxygen deficiency rate of cerium oxide in the region (B) is represented by an oxygen deficiency rate (V_{B}), the oxygen deficiency rate (V_{B}) be 0.5% or more and 30% or less; when a region excluding the region (B) in the region (A) is represented by a region (C) and the oxygen deficiency rate of cerium oxide in the region (C) is represented by an oxygen deficiency rate (V_{C}), the oxygen deficiency rate (V_{C}) be 0% or more and 10% or less; and the oxygen deficiency rate (V_{B}) be larger than the oxygen deficiency rate (V_{C}).

The multilayer film of the present disclosure can be suitably produced by the above-mentioned method.

### EXAMPLES

The present disclosure is described in more detail below by way of Examples. The present disclosure is by no means limited to Examples below.

Materials used for producing and evaluating multilayer films in Examples are described below.

### (Base Materials)

Flat plates made of materials described below were used as base materials. When a base material temperature at the time of vapor deposition was 100 °C or more, base materials except those made of resins were used. In the case of any other base material temperature, all of the following base materials were used. Base materials made of silicon and sodium chloride were each used for analyzing an oxygen deficiency rate and measuring a thickness with an electron microscope.
Borosilicate glass: thickness of 3 mm
Synthetic quartz: thickness of 3 mm
Polycarbonate resin: thickness of 2 mm
Polymethyl methacrylate resin: thickness of 2 mm
Silicon: thickness of 1 mm
Sodium chloride: thickness of 2 mm

### (Film Forming Materials)

Materials described below were used.
Ce: granular, purity of 99.9%
CeO₂: cylindrical, purity of 99.9%
La₂O₃: cylindrical, purity of 99.9%
Sm₂O₃: cylindrical, purity of 99.9%
SiO: granular, purity of 99.9%
SiO₂: granular, purity of 99.9%
Al₂O₃: granular, purity of 99.95%
MgF₂: granular, purity of 99.9%
Ti₃O₅: granular, purity of 99.9%
TaO: granular, purity of 99.9%
Cr: granular, purity of 99.9%

### (Gases for Ion-Assisted Deposition)

O₂: gas, purity of 99.999%
Ar: gas, purity of 99.999%

### (Gas for Vacuum Leakage Testing)

He: gas, purity of 99.99990%

### (Gas for Etching at Time of Measurement)

Ar: gas, purity of 99.99990%

### (Reagents and the Like)

Pure water: JIS K0557 A4
Stearic acid: JIS K8585 special grade, purity of 99.9%
Heptane: JIS K9701 special grade, purity of 99.9%

### (Production of Multilayer Film)

A film forming method and film forming conditions common to Examples and Comparative Examples in the production of a multilayer film are described. A vacuum vapor deposition apparatus (dome diameter: φ1,300 mm, vapor deposition distance: 1,100 mm) was used as a film forming apparatus.

A temperature distribution, the film forming rate of the film forming material, the incident ion distribution of ion-assisted deposition, and the like were adjusted to be the same in all base materials installed on a dome and a monitor base material so that the same multilayer film was obtained on all the base materials installed in the vapor deposition apparatus. For the adjustment, measurement with a Faraday cup, a thermocouple, a thickness measuring device, and the like, the arrangement of a correction plate and a sheathed heater, and the optimization of a heater output were repeated.

Before film formation, the periphery of an evaporation source, a dome, and a wall surface in the apparatus were polished and wiped out with an organic solvent (isohexane).

Subsequently, the above-mentioned film forming materials and various kinds of clean base materials were set in the vacuum vapor deposition apparatus.

A vapor deposition material for forming a film with an electron gun was placed in a clean and degassed hearth liner made of molybdenum, and was evaporated. A clean and degassed holder made of SUS316LN was used as a base material holder.

Analysis and analytical evaluation may be difficult when a test piece to be obtained is only the multilayer film. Accordingly, various kinds of base materials were set in a mechanism capable of exchanging a base material for each layer so that not only the multilayer film but also a monolayer film for analysis and analytical evaluation was obtained at the same time.

After that, evacuation was performed until a degree of vacuum and partial pressures of water molecules and oxygen molecules for starting the film formation were reached. A cryochiller (PFC-1102HC, manufactured by Polycold Systems Inc.) was used in combination with a rotary pump and a diffusion pump in a vacuum evacuation apparatus.

Before the start of the film formation process, it was recognized that there was almost no leakage in the vacuum vapor deposition apparatus by using a He gas for leakage detection and a quadrupole mass spectrometer (Qulee with YTP-H, manufactured by ULVAC, Inc.) as a leakage detector. As recognition items, it was recognized that the mass spectrometer did not detect He gas for leakage detection and the ratio of nitrogen molecules (mass number: 28) to oxygen molecules (mass number: 32) was clearly different from the ratio thereof in the atmosphere (N₂:O₂=79%:21%).

Before the start of the film formation of the layer 13 containing cerium oxide, the partial pressure of water molecules and the partial pressure of oxygen molecules in the atmosphere were measured and calculated with an ionization vacuum gauge and a quadrupole mass spectrometer.

In addition, during the film formation of the region (B) of the layer 13 containing cerium oxide, the partial pressure of water molecules and the partial pressure of oxygen species (an oxygen atom, an oxygen molecule, and an oxygen ion) were measured and calculated every one second with the ionization vacuum gauge and the quadrupole mass spectrometer, those partial pressures were summed and averaged, and an average partial pressure during the film formation of the region (B) was calculated.

A base material temperature during the film formation is −15 °C or more and 600 °C or less. The film formation process was started after the lapse of 15 minutes or more from the time when the base material temperature reached the set temperature±2 °C.

After that, a multilayer film of the film forming materials was formed on the set base material by a vacuum vapor deposition method as shown in Table 1-1 to Table 1-8 to provide a test piece.

Unless otherwise stated, the layer containing cerium oxide was deposited at a film forming rate of 0.5 nm/s. A dome rotation speed during the film formation of each layer was set to 20 rpm. A film formed of two components, such as CeO₂+Al₂O₃ or SiO₂+Al₂O₃, was formed by a binary vapor deposition method, which was a method including placing two kinds of film forming materials in two heating sources, respectively, and evaporating the materials simultaneously. When MgF₂ and SiO were used as film forming materials, a tantalum boat and resistance heating were used as heating sources.

In each of Examples 1 to 66 and Comparative Examples 1 to 22, there was no substantial difference between the multilayer films each obtained by changing the kind of the base material, and hence only one example is shown in each of Table 1-1 to Table 1-8. In addition, in each of Table 1-1 to Table 1-8, the term “crystalline” means that the layer containing cerium oxide contains cerium oxide having a cubic polycrystalline structure, and the term “amorphous” means that the layer containing cerium oxide is free of cerium oxide having a cubic polycrystalline structure. In each of Table 1-1 to Table 1-8, the term “columnar” means that the layer containing cerium oxide contains cerium oxide having a columnar structure, and the term “non-columnar” means that the layer containing cerium oxide is free of cerium oxide having a columnar structure.

Individual conditions in each of Examples and Comparative examples in the production of a multilayer film are described below.

### Example 1

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.53×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B): a region of the layer containing cerium oxide positioned within 8 nm from an interface between the layer containing cerium oxide and the layer containing silicon oxide or the layer containing magnesium fluoride) was 3.11×10⁻³ Pa on average. Other film forming conditions are as described in the section (Production of Multilayer Film).

### Example 2

Vacuum evacuation was performed while the base material temperature of a vacuum vapor deposition apparatus was set to 400 °C and a wall heater was set to 105 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.50×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.06×10⁻³ Pa on average. Other film forming conditions are as described in the section (Production of Multilayer Film).

### Example 3

Vacuum evacuation was performed while the base material temperature of a vacuum vapor deposition apparatus was set to 400 °C and a wall heater was set to 110 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.50×10⁻⁴ Pa. After that, a layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 3.05×10⁻³ Pa on average. Other film forming conditions are as described in the section (Production of Multilayer Film).

### Example 4

Vacuum evacuation was performed while the base material temperature of a vacuum vapor deposition apparatus was set to 400 °C and a wall heater was set to 115 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.49×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.03×10⁻³ Pa on average. Other film forming conditions are as described in the section (Production of Multilayer Film).

### Example 5

Vacuum evacuation was performed while the base material temperature of a vacuum vapor deposition apparatus was set to 400 °C and a wall heater was set to 140 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.48×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.00×10⁻³ Pa on average. Other film forming conditions are as described in the section (Production of Multilayer Film).

### Example 6

Vacuum evacuation was performed while the base material temperature of a vacuum vapor deposition apparatus was set to 400 °C and a wall heater was set to 120 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.47×10⁻⁴ Pa. After that, a layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.98×10⁻³ Pa on average. Other film forming conditions are as described in the section (Production of Multilayer Film).

### Example 7

Vacuum evacuation was performed while the base material temperature of a vacuum vapor deposition apparatus was set to 400 °C and a wall heater was set to 125 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.96×10⁻³ Pa on average. Other film forming conditions are as described in the section (Production of Multilayer Film).

### Example 8

Vacuum evacuation was performed while the base material temperature of a vacuum vapor deposition apparatus was set to 400 °C and a wall heater was set to 130 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.94×10⁻³ Pa on average. Other film forming conditions are as described in the section (Production of Multilayer Film).

### Example 9

Vacuum evacuation was performed while the base material temperature of a vacuum vapor deposition apparatus was set to 400 °C and a wall heater was set to 135 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.44×10⁻⁴ Pa. After that, a layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.92×10⁻³ Pa on average. Other film forming conditions are as described in the section (Production of Multilayer Film).

### Example 10

Vacuum evacuation was performed while the base material temperature of a vacuum vapor deposition apparatus was set to 400 °C and a wall heater was set to 140 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.39×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.84×10⁻³ Pa on average. Other film forming conditions are as described in the section (Production of Multilayer Film).

### Example 11

Vacuum evacuation was performed while the base material temperature of a vacuum vapor deposition apparatus was set to 400 °C and a wall heater was set to 145 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.38×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.80×10⁻³ Pa on average. Other film forming conditions are as described in the section (Production of Multilayer Film).

### Example 12

Vacuum evacuation was performed while the base material temperature of a vacuum vapor deposition apparatus was set to 400 °C and a wall heater was set to 150 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.37×10⁻⁴ Pa. After that, a layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.78×10⁻³ Pa on average. Other film forming conditions are as described in the section (Production of Multilayer Film).

### Example 13

Vacuum evacuation was performed while the base material temperature of a vacuum vapor deposition apparatus was set to 400 °C and a wall heater was set to 155 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.34×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.73×10⁻³ Pa on average. Other film forming conditions are as described in the section (Production of Multilayer Film).

### Example 14

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.33×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.71×10⁻³ Pa on average. Other film forming conditions are as described in the section (Production of Multilayer Film).

### Example 15

Vacuum evacuation was performed while the base material temperature of a vacuum vapor deposition apparatus was set to 400 °C and a wall heater was set to 165 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.26×10⁻⁴ Pa. After that, a layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.57×10⁻³ Pa on average. Other film forming conditions are as described in the section (Production of Multilayer Film).

### Example 16

Vacuum evacuation was performed while the base material temperature of a vacuum vapor deposition apparatus was set to 400 °C and a wall heater was set to 150 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.71×10⁻⁴ Pa. After that, a layer containing cerium oxide was formed on each of various kinds of base materials at a film forming rate of 0.7 nm/s through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 4.89×10⁻³ Pa on average. Other film forming conditions are as described in the section (Production of Multilayer Film).

### Example 17

Vacuum evacuation was performed while the base material temperature of a vacuum vapor deposition apparatus was set to 400 °C and a wall heater was set to 175 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.78×10⁻⁴ Pa. After that, a layer containing cerium oxide was formed on each of various kinds of base materials at a film forming rate of 1.0 nm/s through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 7.23×10⁻³ Pa on average. Other film forming conditions are as described in the section (Production of Multilayer Film).

### Example 18

Vacuum evacuation was performed while the base material temperature of a vacuum vapor deposition apparatus was set to 400 °C and a wall heater was set to 180 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.96×10⁻⁴ Pa. After that, a layer containing cerium oxide was formed on each of various kinds of base materials at a film forming rate of 1.5 nm/s through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 1.20×10⁻² Pa on average. Other film forming conditions are as described in the section (Production of Multilayer Film).

### Example 19

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.87×10⁻⁴ Pa. After that, a layer containing cerium oxide was formed on each of various kinds of base materials through use of Ce and CeO₂ as film forming materials. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 5.84×10⁻³ Pa on average. Other film forming conditions are as described in the section (Production of Multilayer Film).

### Example 20

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.83×10⁻⁴ Pa. After that, a layer containing cerium oxide was formed on each of various kinds of base materials through use of Ce and CeO₂ as film forming materials. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 5.76×10⁻³ Pa on average. Other film forming conditions are as described in the section (Production of Multilayer Film).

### Example 21

Vacuum evacuation was performed while the base material temperature of a vacuum vapor deposition apparatus was set to 400 °C and a wall heater was set to 200 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.03×10⁻⁴ Pa. After that, a layer containing cerium oxide was formed on each of various kinds of base materials at a film forming rate of 0.65 nm/s through use of Sm₂O₃ and CeO₂ as film forming materials. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.71×10⁻³ Pa on average. Other film forming conditions are as described in the section (Production of Multilayer Film).

### Example 22

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.83×10⁻⁴ Pa. After that, a layer containing cerium oxide was formed on each of various kinds of base materials through use of Ce and CeO₂ as film forming materials. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 5.76×10⁻³ Pa on average. Other film forming conditions are as described in the section (Production of Multilayer Film).

### Example 23

Vacuum evacuation was performed while the base material temperature of a vacuum vapor deposition apparatus was set to 250 °C and a wall heater was set to 100 °C. After the lapse of 15 minutes or more from the time when the base material temperature reached 250±2 °C, and before the start of a film formation process for a layer containing cerium oxide, the total value of the partial pressure of water molecules and the partial pressure of oxygen molecules was recognized to be 1.51×10⁻⁴ Pa. After that, a layer containing cerium oxide was formed on each of various kinds of base materials through use of CeO₂ as a film forming material. When the layer containing cerium oxide was formed, ion-assisted deposition with an RF ion source was performed. Conditions for the ion-assisted deposition are an accelerating voltage value of 700 V, an accelerating current value of 700 mA, and an O₂ gas flow rate of 60 sscm. In addition, when 8 nm on the surface layer side of the layer containing cerium oxide (region (B)) was formed, the film was formed while an ion gun and gas introduction were stopped. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 24

Vacuum evacuation was performed while the base material temperature of a vacuum vapor deposition apparatus was set to 350 °C and a wall heater was set to 100 °C. After the lapse of 15 minutes or more from the time when the base material temperature reached 350±2 °C, and before the start of a film formation process for a layer containing cerium oxide, the total value of the partial pressure of water molecules and the partial pressure of oxygen molecules was recognized to be 1.49×10⁻⁴ Pa. After that, a layer containing cerium oxide was formed on each of various kinds of base materials through use of CeO₂ as a film forming material. When the layer containing cerium oxide was formed, oxygen was introduced by Auto Pressure Control (APC). The introduction amount of an oxygen gas is 1.9×10⁻² Pa. In addition, when 8 nm on the surface layer side of the layer containing cerium oxide (region (B)) was formed, the film was formed 1 minute after the oxygen gas introduction had been stopped. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.03×10⁻³ Pa on average. Other film forming conditions are as described in the section (Production of Multilayer Film).

### Example 25

Vacuum evacuation was performed while the base material temperature of a vacuum vapor deposition apparatus was set to 300 °C and a wall heater was set to 100 °C. After the lapse of 15 minutes or more from the time when the base material temperature reached 300±2 °C, and before the start of a film formation process for a layer containing cerium oxide, the total value of the partial pressure of water molecules and the partial pressure of oxygen molecules was recognized to be 1.45×10⁻⁴ Pa. After that, a layer containing cerium oxide was formed on each of various kinds of base materials through use of CeO₂ as a film forming material. When the layer containing cerium oxide was formed, ion-assisted deposition with an RF ion source was performed. Conditions for the ion-assisted deposition are an accelerating voltage value of 700 V, an accelerating current value of 700 mA, an O₂ gas flow rate of 35 sscm, and an Ar gas flow rate of 7 sccm. In addition, when 8 nm on the surface layer side of the layer containing cerium oxide (region (B)) was formed, the film was formed while an ion gun and gas introduction were stopped. Subsequently, a SiO₂+Al₂O₃ film (low-refractive-index layer) was formed thereon through use of SiO₂ and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.95×10⁻³ Pa on average. Other film forming conditions are as described in the section (Production of Multilayer Film).

### Example 26

Vacuum evacuation was performed while the base material temperature of a vacuum vapor deposition apparatus was set to 300 °C and a wall heater was set to 100 °C. After the lapse of 15 minutes or more from the time when the base material temperature reached 300±2 °C, and before the start of a film formation process for a layer containing cerium oxide, the total value of the partial pressure of water molecules and the partial pressure of oxygen molecules was recognized to be 1.39×10⁻⁴ Pa. After that, a layer containing cerium oxide was formed on each of various kinds of base materials through use of CeO₂ as a film forming material. When the layer containing cerium oxide was formed, ion-assisted deposition with an RF ion source was performed. Conditions for the ion-assisted deposition are an accelerating voltage value of 700 V, an accelerating current value of 700 mA, an O₂ gas flow rate of 30 sscm, and an Ar gas flow rate of 10 sccm. In addition, when 8 nm on the surface layer side of the layer containing cerium oxide (region (B)) was formed, the film was formed while an ion gun and gas introduction were stopped. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.83×10⁻³ Pa on average. Other film forming conditions are as described in the section (Production of Multilayer Film).

### Example 27

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.45×10⁻⁴ Pa. After that, a layer containing cerium oxide was formed on each of various kinds of base materials at a film forming rate of 2.0 nm/s through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 1.99×10⁻² Pa on average. Other film forming conditions are as described in the section (Production of Multilayer Film).

### Example 28

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.87×10⁻⁴ Pa. After that, a layer containing cerium oxide was formed on each of various kinds of base materials through use of Ce and CeO₂ as film forming materials. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 5.84×10⁻³ Pa on average. Other film forming conditions are as described in the section (Production of Multilayer Film).

### Example 29

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 30

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 31

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.50×10⁻⁴ Pa. After that, a layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 3.05×10⁻³ Pa on average. Other film forming conditions are as described in the section (Production of Multilayer Film).

### Example 32

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.47×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.98×10⁻³ Pa on average. Other film forming conditions are as described in the section (Production of Multilayer Film).

### Example 33

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.95×10⁻³ Pa on average. Other film forming conditions are as described in the section (Production of Multilayer Film).

### Example 34

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.42×10⁻⁴ Pa. After that, a layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.89×10⁻³ Pa on average. Other film forming conditions are as described in the section (Production of Multilayer Film).

### Example 35

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.38×10⁻⁴ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.80×10⁻³ Pa on average. Other film forming conditions are as described in the section (Production of Multilayer Film).

### Example 36

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.37× 10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.80×10⁻³ Pa on average. Other film forming conditions are as described in the section (Production of Multilayer Film).

### Example 37

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.31×10⁴ Pa. After that, a layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.66×10⁻³ Pa on average. Other film forming conditions are as described in the section (Production of Multilayer Film).

### Example 38

Vacuum evacuation was performed while the base material temperature of a vacuum vapor deposition apparatus was set to 400 °C and a wall heater was set to 200 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 9.84×10⁻⁵ Pa. After that, a layer containing cerium oxide was formed on each of various kinds of base materials at a film forming rate of 0.7 nm/s through use of La₂O₃ and CeO₂ as film forming materials. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.80×10⁻³ Pa on average. Other film forming conditions are as described in the section (Production of Multilayer Film).

### Example 39

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.87×10−4 Pa. A layer containing cerium oxide was formed on each of various kinds of base materials through use of Ce and CeO₂ as film forming materials. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 5.84×10⁻³ Pa on average. Other film forming conditions are as described in the section (Production of Multilayer Film).

### Example 40

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.27×10⁻⁴ Pa. A layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.59×10⁻³ Pa on average. Other film forming conditions are as described in the section (Production of Multilayer Film).

### Example 41

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 42

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.37×10⁻⁴ Pa. A layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.79×10⁻³ Pa on average. Other film forming conditions are as described in the section (Production of Multilayer Film).

### Example 43

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 44

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.94×10⁻³ Pa on average. Other film forming conditions are as described in the section (Production of Multilayer Film).

### Example 45

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 46

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10−4 Pa. A layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.95×10⁻³ Pa on average. Other film forming conditions are as described in the section (Production of Multilayer Film).

### Example 47

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 3.07×10⁻³ Pa on average. Other film forming conditions are as described in the section (Production of Multilayer Film).

### Example 48

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.41×10−4 Pa. A layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.87×10⁻³ Pa on average. Other film forming conditions are as described in the section (Production of Multilayer Film).

### Example 49

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.07×10⁻³ Pa on average. Other film forming conditions are as described in the section (Production of Multilayer Film).

### Example 50

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.37×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.78×10⁻³ Pa on average. Other film forming conditions are as described in the section (Production of Multilayer Film).

### Example 51

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.51×10⁻⁴ Pa. A layer containing cerium oxide was formed on each of various kinds of base materials through use of CeO₂ as a film forming material. Subsequently, a SiO₂+Al₂O₃ film (low-refractive-index layer) was formed thereon through use of SiO₂ and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 3.08×10⁻³ Pa on average. Other film forming conditions are as described in the section (Production of Multilayer Film).

### Example 52

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.45×10⁻⁴ Pa. A layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.95×10⁻³ Pa on average. Other film forming conditions are as described in the section (Production of Multilayer Film).

### Example 53

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.50×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO₂ as a film forming material to produce a multilayer film. The total value of the partial pressure of water molecules and the partial pressure of oxygen species during the film formation of 8 nm on the surface layer side of the layer containing cerium oxide (region (B)) was 3.05×10⁻³ Pa on average. Other film forming conditions are as described in the section (Production of Multilayer Film).

### Example 54

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.44×10⁻⁴ Pa. A layer containing cerium oxide was formed on each of various kinds of base materials through use of CeO₂ as a film forming material. Subsequently, a SiO₂+CeO₂ film (low-refractive-index layer) was formed thereon through use of SiO₂ and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.94×10⁻³ Pa on average. Other film forming conditions are as described in the section (Production of Multilayer Film).

### Example 55

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.37×10⁻⁴ Pa. A layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 2.79×10⁻³ Pa on average. Other film forming conditions are as described in the section (Production of Multilayer Film).

### Example 56

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.22×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.49×10⁻³ Pa on average. Other film forming conditions are as described in the section (Production of Multilayer Film).

### Example 57

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.08×10−4 Pa. A layer containing cerium oxide was formed on each of various kinds of base materials at a film forming rate of 3.0 nm/s through use of CeO₂ as a film forming material. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 2.54×10⁻² Pa on average. Other film forming conditions are as described in the section (Production of Multilayer Film).

### Example 58

Vacuum evacuation was performed while the base material temperature of a vacuum vapor deposition apparatus was set to 400 °C and a wall heater was set to 160 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.87×10⁻⁴ Pa. A layer containing cerium oxide was formed on each of various kinds of base materials through use of Ce and CeO₂ as film forming materials. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 3.51×10⁻² Pa on average. Other film forming conditions are as described in the section (Production of Multilayer Film).

### Example 59

Vacuum evacuation was performed while the substrate heating of a vacuum vapor deposition apparatus was set to OFF and a wall heater was set to 50 °C. A substrate temperature before film formation was 28 °C. Before the start of a film formation process for a layer containing cerium oxide, the total value of the partial pressure of water molecules and the partial pressure of oxygen molecules was recognized to be 1.22×10⁻⁴ Pa. A layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.48×10⁻³ Pa on average. Other film forming conditions are as described in the section (Production of Multilayer Film).

### Example 60

Vacuum evacuation was performed while the substrate heating of a vacuum vapor deposition apparatus was set to OFF and a wall heater was set to 50 °C. A substrate temperature before film formation was 31 °C. Before the start of a film formation process for a layer containing cerium oxide, the total value of the partial pressure of water molecules and the partial pressure of oxygen molecules was recognized to be 1.45×10⁻⁴ Pa. A layer containing cerium oxide was formed on each of various kinds of base materials through use of CeO₂ as a film forming material. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 2.95×10⁻³ Pa on average. Other film forming conditions are as described in the section (Production of Multilayer Film).

### Example 61

Vacuum evacuation was performed while the base material temperature of a vacuum vapor deposition apparatus was set to 100 °C and a wall heater was set to 100 °C. After the lapse of 15 minutes or more from the time when the base material temperature reached 100±2 °C, and before the start of a film formation process for a layer containing cerium oxide, the total value of the partial pressure of water molecules and the partial pressure of oxygen molecules was recognized to be 9.54×10⁻⁵ Pa. After that, a layer containing cerium oxide was formed on each of various kinds of base materials through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 1.94×10⁻³ Pa on average. Other film forming conditions are as described in the section (Production of Multilayer Film).

### Example 62

Vacuum evacuation was performed while the base material temperature of a vacuum vapor deposition apparatus was set to 100 °C and a wall heater was set to 100 °C. After the lapse of 15 minutes or more from the time when the base material temperature reached 100±2 °C, and before the start of a film formation process for a layer containing cerium oxide, the total value of the partial pressure of water molecules and the partial pressure of oxygen molecules was recognized to be 1.36×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.78×10⁻³ Pa on average. Other film forming conditions are as described in the section (Production of Multilayer Film).

### Example 63

Vacuum evacuation was performed while the base material temperature of a vacuum vapor deposition apparatus was set to 270 °C and a wall heater was set to 100 °C. After the lapse of 15 minutes or more from the time when the base material temperature reached 270±2 °C, and before the start of a film formation process for a layer containing cerium oxide, the total value of the partial pressure of water molecules and the partial pressure of oxygen molecules was recognized to be 2.87×10⁴ Pa. After that, a layer containing cerium oxide was formed on each of various kinds of base materials through use of Ce and CeO₂ as film forming materials. Subsequently, a SiO₂+Al₂O₃ film (low-refractive-index layer) was formed thereon through use of SiO and Al₂O₃ as film forming materials to produce a multilayer film. The total value of the partial pressure of water molecules and the partial pressure of oxygen species during the film formation of 8 nm on the surface layer side of the layer containing cerium oxide (region (B)) was 5.84×10⁻³ Pa on average. Other film forming conditions are as described in the section (Production of Multilayer Film).

### Example 64

Vacuum evacuation was performed while the base material temperature of a vacuum vapor deposition apparatus was set to 270 °C and a wall heater was set to 100 °C. After the lapse of 15 minutes or more from the time when the base material temperature reached 270±2 °C, and before the start of a film formation process for a layer containing cerium oxide, the total value of the partial pressure of water molecules and the partial pressure of oxygen molecules was recognized to be 1.84×10⁻⁴ Pa. After that, a layer containing cerium oxide was formed on each of various kinds of base materials at a film forming rate of 1.0 nm/s through use of CeO₂ as a film forming material. Subsequently, a MgF₂ film (low-refractive-index layer) was formed thereon through use of MgF₂ as a film forming material to produce a multilayer film. The total value of the partial pressure of water molecules and the partial pressure of oxygen species during the film formation of 8 nm on the surface layer side of the layer containing cerium oxide (region (B)) was 7.50×10⁻³ Pa on average. Other film forming conditions are as described in the section (Production of Multilayer Film).

### Example 65

Vacuum evacuation was performed while the base material temperature of a vacuum vapor deposition apparatus was set to 500 °C and a wall heater was set to 200 °C. After the lapse of 15 minutes or more from the time when the base material temperature reached 500±2 °C, and before the start of a film formation process for a layer containing cerium oxide, the total value of the partial pressure of water molecules and the partial pressure of oxygen molecules was recognized to be 1.37×10⁻⁴ Pa. After that, a layer containing cerium oxide was formed on each of various kinds of base materials through use of CeO₂ as a film forming material. Subsequently, a SiO₂ film (low-refractive-index layer) was formed thereon through use of SiO as a film forming material to produce a multilayer film. The total value of the partial pressure of water molecules and the partial pressure of oxygen species during the film formation of 8 nm on the surface layer side of the layer containing cerium oxide (region (B)) was 2.79×10⁻³ Pa on average. Other film forming conditions are as described in the section (Production of Multilayer Film).

### Example 66

Vacuum evacuation was performed while the base material temperature of a vacuum vapor deposition apparatus was set to 500 °C and a wall heater was set to 200 °C. After the lapse of 15 minutes or more from the time when the base material temperature reached 500±2 °C, and before the start of a film formation process for a layer containing cerium oxide, the total value of the partial pressure of water molecules and the partial pressure of oxygen molecules was recognized to be 2.87×10⁻⁴ Pa. After that, a layer containing cerium oxide was formed on each of various kinds of base materials at a film forming rate of 0.7 nm/s through use of Y₂O₃ and CeO₂ as film forming materials. Subsequently, a SiO₂+CeO₂ film (low-refractive-index layer) was formed thereon through use of SiO and CeO₂ as film forming materials to produce a multilayer film. The total value of the partial pressure of water molecules and the partial pressure of oxygen species during the film formation of 8 nm on the surface layer side of the layer containing cerium oxide (region (B)) was 8.18×10⁻³ Pa on average. Other film forming conditions are as described in the section (Production of Multilayer Film).

### Comparative Example 1

Vacuum evacuation was performed while the base material temperature of a vacuum vapor deposition apparatus was set to 300 °C and a wall heater was set to 50 °C. Before the start of a film formation process for a layer containing cerium oxide, the total value of the partial pressure of water molecules and the partial pressure of oxygen molecules was recognized to be 8.20×10⁻³ Pa. After that, a layer containing cerium oxide was formed on each of various kinds of base materials at a film forming rate of 0.2 nm/s through use of CeO₂ as a film forming material. Subsequently, a SiO₂ film (low-refractive-index layer) was formed thereon through use of SiO₂ as a film forming material to produce a multilayer film. The total value of the partial pressure of water molecules and the partial pressure of oxygen species during the film formation of 8 nm on the surface layer side of the layer containing cerium oxide (region (B)) was 6.68×10⁻² Pa on average. Other film forming conditions are as described in the section (Production of Multilayer Film).

### Comparative Example 2

Vacuum evacuation was performed while the base material temperature of a vacuum vapor deposition apparatus was set to 400 °C and a wall heater was set to 100 °C. Before the start of a film formation process for a layer containing cerium oxide, the total value of the partial pressure of water molecules and the partial pressure of oxygen molecules was recognized to be 6.15×10⁻³ Pa. After that, a layer containing cerium oxide was formed on each of various kinds of base materials at a film forming rate of 0.2 nm/s through use of CeO₂ as a film forming material. Subsequently, a SiO₂+CeO₂ film (low-refractive-index layer) was formed thereon through use of SiO₂ and CeO₂ as film forming materials to produce a multilayer film. The total value of the partial pressure of water molecules and the partial pressure of oxygen species during the film formation of 8 nm on the surface layer side of the layer containing cerium oxide (region (B)) was 5.01×10⁻² Pa on average. Other film forming conditions are as described in the section (Production of Multilayer Film).

### Comparative Example 3

Vacuum evacuation was performed while the base material temperature of a vacuum vapor deposition apparatus was set to 400 °C and a wall heater was set to 100 °C. Before the start of a film formation process for a layer containing cerium oxide, the total value of the partial pressure of water molecules and the partial pressure of oxygen molecules was recognized to be 1.53×10⁻⁴ Pa. After that, a layer containing cerium oxide was formed on each of various kinds of base materials at a film forming rate of 0.2 nm/s through use of CeO₂ as a film forming material. When the layer containing cerium oxide was formed, an O₂ gas was introduced so that a degree of vacuum was 1.8×10⁻² Pa with an Auto Pressure Control (APC) device. The total value of the partial pressure of water molecules and the partial pressure of oxygen species during the film formation of 8 nm on the surface layer side of the layer containing cerium oxide (region (B)) was 1.80×10⁻² Pa on average. Subsequently, a MgF₂ film (low-refractive-index layer) was formed thereon through use of MgF₂ as a film forming material to produce a multilayer film. Other film forming conditions are as described in the section (Production of Multilayer Film).

### Comparative Example 4

Vacuum evacuation was performed while the base material temperature of a vacuum vapor deposition apparatus was set to 400 °C and a wall heater was set to 100 °C. Before the start of a film formation process for a layer containing cerium oxide, the total value of the partial pressure of water molecules and the partial pressure of oxygen molecules was recognized to be 1.53×10⁻⁴ Pa. After that, a layer containing cerium oxide was formed on each of various kinds of base materials at a film forming rate of 0.2 nm/s through use of CeO₂ as a film forming material. When 8 nm on the surface layer side of the layer containing cerium oxide (region (B)) was formed, ion-assisted deposition with an RF ion source was performed. Conditions for the ion-assisted deposition were an accelerating voltage value of 700 V, an accelerating current value of 700 mA, and an O₂ gas flow rate of 50 sscm. The total value of the partial pressure of water molecules and the partial pressure of oxygen species during the film formation of 8 nm on the surface layer side of the layer containing cerium oxide (region (B)) was 3.11×10⁻³ Pa on average. Subsequently, a SiO₂ film (low-refractive-index layer) was formed thereon through use of SiO as a film forming material to produce a multilayer film. Other film forming conditions are as described in the section (Production of Multilayer Film).

### Comparative Example 5

Vacuum evacuation was performed while the base material temperature of a vacuum vapor deposition apparatus was set to 400 °C and a wall heater was set to 150 °C. Before the start of a film formation process for a layer containing cerium oxide, the total value of the partial pressure of water molecules and the partial pressure of oxygen molecules was recognized to be 2.91×10⁻⁴ Pa. After that, a layer containing cerium oxide was formed on each of various kinds of base materials at a film forming rate of 0.9 nm/s through use of Ce and CeO₂ as film forming materials. When 8 nm on the surface layer side of the layer containing cerium oxide (region (B)) was formed, the film was formed by changing the film forming rate to 0.1 nm/s. The total value of the partial pressure of water molecules and the partial pressure of oxygen species during the film formation of 8 nm on the surface layer side of the layer containing cerium oxide (region (B)) was 1.07×10⁻² Pa on average. Subsequently, a SiO₂+Al₂O₃ film (low-refractive-index layer) was formed thereon through use of SiO and Al₂O₃ as film forming materials to produce a multilayer film. Other film forming conditions are as described in the section (Production of Multilayer Film).

### Comparative Example 6

Vacuum evacuation was performed while the base material temperature of a vacuum vapor deposition apparatus was set to 400 °C and a wall heater was set to 150 °C. Before the start of a film formation process for a layer containing cerium oxide, the total value of the partial pressure of water molecules and the partial pressure of oxygen molecules was recognized to be 2.87×10⁻⁴ Pa. After that, a layer containing cerium oxide was formed on each of various kinds of base materials at a film forming rate of 1.0 nm/s through use of Ce and CeO₂ as film forming materials. When 8 nm on the surface layer side of the layer containing cerium oxide (region (B)) was formed, the film was formed by changing the film forming rate to 0.1 nm/s. The total value of the partial pressure of water molecules and the partial pressure of oxygen species during the film formation of 8 nm on the surface layer side of the layer containing cerium oxide (region (B)) was 1.17×10⁻² Pa on average. Subsequently, a MgF₂ film (low-refractive-index layer) was formed thereon through use of MgF₂ as a film forming material to produce a multilayer film. Other film forming conditions are as described in the section (Production of Multilayer Film).

### Comparative Example 7

Vacuum evacuation was performed while the base material temperature of a vacuum vapor deposition apparatus was set to 400 °C and a wall heater was set to 150 °C. Before the start of a film formation process for a layer containing cerium oxide, the total value of the partial pressure of water molecules and the partial pressure of oxygen molecules was recognized to be 2.83×10⁻⁴ Pa. After that, a layer containing cerium oxide was formed on each of various kinds of base materials at a film forming rate of 1.1 nm/s through use of Ce and CeO₂ as film forming materials. When 8 nm on the surface layer side of the layer containing cerium oxide (region (B)) was formed, the film was formed by changing the film forming rate to 0.1 nm/s. The total value of the partial pressure of water molecules and the partial pressure of oxygen species during the film formation of 8 nm on the surface layer side of the layer containing cerium oxide (region (B)) was 1.27×10⁻² Pa on average. Subsequently, a SiO₂ film (low-refractive-index layer) was formed thereon through use of SiO as a film forming material to produce a multilayer film. Other film forming conditions are as described in the section (Production of Multilayer Film).

### Comparative Example 8

Vacuum evacuation was performed while the base material temperature of a vacuum vapor deposition apparatus was set to 400 °C and a wall heater was set to 150 °C. Before the start of a film formation process for a layer containing cerium oxide, the total value of the partial pressure of water molecules and the partial pressure of oxygen molecules was recognized to be 2.79×10⁻⁴ Pa. After that, a layer containing cerium oxide was formed on each of various kinds of base materials at a film forming rate of 1.2 nm/s through use of Ce and CeO₂ as film forming materials. When 8 nm on the surface layer side of the layer containing cerium oxide (region (B)) was formed, the film was formed by changing the film forming rate to 0.1 nm/s. The total value of the partial pressure of water molecules and the partial pressure of oxygen species during the film formation of 8 nm on the surface layer side of the layer containing cerium oxide (region (B)) was 1.36×10⁻² Pa on average. Subsequently, a SiO₂+CeO₂ film (low-refractive-index layer) was formed thereon through use of SiO and CeO₂ as film forming materials to produce a multilayer film. Other film forming conditions are as described in the section (Production of Multilayer Film).

### Comparative Example 9

Vacuum evacuation was performed while the base material temperature of a vacuum vapor deposition apparatus was set to 400 °C and a wall heater was set to 150 °C. Before the start of a film formation process for a layer containing cerium oxide, the total value of the partial pressure of water molecules and the partial pressure of oxygen molecules was recognized to be 2.75×10⁻⁴ Pa. After that, a layer containing cerium oxide was formed on each of various kinds of base materials at a film forming rate of 1.4 nm/s through use of Ce and CeO₂ as film forming materials. When 8 nm on the surface layer side of the layer containing cerium oxide (region (B)) was formed, the film was formed by changing the film forming rate to 0.1 nm/s. The total value of the partial pressure of water molecules and the partial pressure of oxygen species during the film formation of 8 nm on the surface layer side of the layer containing cerium oxide (region (B)) was 1.57×10⁻² Pa on average. Subsequently, a MgF₂ film (low-refractive-index layer) was formed thereon through use of MgF₂ as a film forming material to produce a multilayer film. Other film forming conditions are as described in the section (Production of Multilayer Film).

### Comparative Example 10

Vacuum evacuation was performed while the base material temperature of a vacuum vapor deposition apparatus was set to 400 °C and a wall heater was set to 100 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 1.53×10⁻⁴ Pa. After that, a layer containing cerium oxide was formed on each of various kinds of base materials through use of CeO₂ as a film forming material. When the layer containing cerium oxide was formed, oxygen was introduced by APC. The introduction amount of an oxygen gas is 5.0×10⁻² Pa. The total value of the partial pressure of water molecules and the partial pressure of oxygen species during the film formation of 8 nm on the surface layer side of the layer containing cerium oxide (region (B)) was 5.00×10⁻² Pa on average. Subsequently, a SiO₂ film (low-refractive-index layer) was formed thereon through use of SiO as a film forming material to produce a multilayer film. Other film forming conditions are as described in the section (Production of Multilayer Film).

### Comparative Example 11

Vacuum evacuation was performed while the base material temperature of a vacuum vapor deposition apparatus was set to 250 °C and a wall heater was set to 100 °C. After the lapse of 15 minutes or more from the time when the base material temperature reached 250±2 °C, and before the start of a film formation process for a layer containing cerium oxide, the total value of the partial pressure of water molecules and the partial pressure of oxygen molecules was recognized to be 1.52×10⁻⁴ Pa. After that, a layer containing cerium oxide was formed on each of various kinds of base materials through use of CeO₂ as a film forming material. When the layer containing cerium oxide was formed, ion-assisted deposition with an RF ion source was performed. Conditions for the ion-assisted deposition are an accelerating voltage value of 700 V, an accelerating current value of 700 mA, and an O₂ gas flow rate of 80 sscm. The total value of the partial pressure of water molecules and the partial pressure of oxygen species during the film formation of 8 nm on the surface layer side of the layer containing cerium oxide (region (B)) was 3.09×10⁻² Pa on average. Subsequently, a SiO₂+Al₂O₃ film (low-refractive-index layer) was formed thereon through use of SiO and Al₂O₃ as film forming materials to produce a multilayer film. Other film forming conditions are as described in the section (Production of Multilayer Film).

### Comparative Example 12

Vacuum evacuation was performed while the base material temperature of a vacuum vapor deposition apparatus was set to 250 °C and a wall heater was set to 100 °C. After the lapse of 15 minutes or more from the time when the base material temperature reached 250±2 °C, and before the start of a film formation process for a layer containing cerium oxide, the total value of the partial pressure of water molecules and the partial pressure of oxygen molecules was recognized to be 1.52×10⁴ Pa. After that, a layer containing cerium oxide was formed on each of various kinds of base materials through use of CeO₂ as a film forming material. When the layer containing cerium oxide was formed, ion-assisted deposition with an RF ion source was performed. Conditions for the ion-assisted deposition are an accelerating voltage value of 700 V, an accelerating current value of 700 mA, and an O₂ gas flow rate of 70 sscm. The total value of the partial pressure of water molecules and the partial pressure of oxygen species during the film formation of 8 nm on the surface layer side of the layer containing cerium oxide (region (B)) was 3.02×10⁻² Pa on average. Subsequently, a MgF₂ film (low-refractive-index layer) was formed thereon through use of MgF₂ as a film forming material to produce a multilayer film. Other film forming conditions are as described in the section (Production of Multilayer Film).

### Comparative Example 13

The base material temperature was changed to 600 °C so that a layer containing cerium oxide having a non-columnar structure was obtained instead of the layer containing cerium oxide having a columnar structure in Example 34. Before the start of a film formation process for the layer containing cerium oxide, the total value of the partial pressure of water molecules and the partial pressure of oxygen molecules was recognized to be 1.51×10⁻⁴ Pa. Ion-assisted deposition with an RF ion source was performed in the film formation of the layer containing cerium oxide. Conditions for the ion-assisted deposition are an accelerating voltage value of 900 V, an accelerating current value of 1,000 mA, an O₂ gas flow rate of 6 sscm, and an Ar gas flow rate of 34 sccm. In addition, when 8 nm on the surface layer side of the layer containing cerium oxide (region (B)) was formed, the film was formed by changing the O₂ gas flow rate of the ion source to 2 sscm and the Ar gas flow rate thereof to 38 sccm. The total value of the partial pressure of water molecules and the partial pressure of oxygen species during the film formation of 8 nm on the surface layer side of the layer containing cerium oxide (region (B)) was 3.08×10−3 Pa on average. A multilayer film was produced by the same method as that in Example 34 except for the foregoing.

### Comparative Example 14

The base material temperature was changed to 600 °C so that a layer containing cerium oxide having a non-columnar structure was obtained instead of the layer containing cerium oxide having a columnar structure in Example 36. Before the start of a film formation process for the layer containing cerium oxide, the total value of the partial pressure of water molecules and the partial pressure of oxygen molecules was recognized to be 1.51×10⁻⁴ Pa. Ion-assisted deposition with an RF ion source was performed in the film formation of the layer containing cerium oxide. Conditions for the ion-assisted deposition are an accelerating voltage value of 1,000 V, an accelerating current value of 1,000 mA, an O₂ gas flow rate of 3 sscm, and an Ar gas flow rate of 37 sccm. In addition, when 8 nm on the surface layer side of the layer containing cerium oxide (region (B)) was formed, the film was formed by changing the O₂ gas flow rate of the ion source to 0 sscm and the Ar gas flow rate thereof to 40 sccm. The total value of the partial pressure of water molecules and the partial pressure of oxygen species during the film formation of 8 nm on the surface layer side of the layer containing cerium oxide (region (B)) was 3.07×10⁻³ Pa on average. A multilayer film was produced by the same method as that in Example 36 except for the foregoing.

### Comparative Example 15

The base material temperature was changed to −18 °C so that an amorphous CeO₂ layer was obtained instead of the cubic polycrystalline CeO₂ layer in Example 19, and the wall heater was turned off before vacuum evacuation and film formation. Before the start of a film formation process for a layer containing cerium oxide, the total value of the partial pressure of water molecules and the partial pressure of oxygen molecules was recognized to be 2.38×110⁻⁵ Pa. In addition, the total value of the partial pressure of water molecules and the partial pressure of oxygen species during the film formation of 8 nm on the surface layer side of the layer containing cerium oxide (region (B)) was 4.84×10⁻⁴ Pa on average. A multilayer film was produced by the same method as that in Example 19 except for the foregoing.

### Comparative Example 16

The base material temperature was changed to −18 °C so that an amorphous CeO₂ layer was obtained instead of the cubic polycrystalline CeO₂ layer in Example 20, and the wall heater was turned off before vacuum evacuation and film formation. Before the start of a film formation process for a layer containing cerium oxide, the total value of the partial pressure of water molecules and the partial pressure of oxygen molecules was recognized to be 2.87×10⁻⁴ Pa. In addition, the total value of the partial pressure of water molecules and the partial pressure of oxygen species during the film formation of 8 nm on the surface layer side of the layer containing cerium oxide (region (B)) was 5.84×10⁻³ Pa on average. A multilayer film was produced by the same method as that in Example 20 except for the foregoing.

### Comparative Example 17

A SiO film was formed at a film forming rate of 1.3 nm/s through use of SiO instead of forming the SiO₂ film in Example 24. The SiO film was unsuitable as an optical thin film because the film had a large refractive index and also had a large amount of optical loss due to optical absorption.

### Comparative Example 18

Vacuum evacuation was performed while the base material temperature of a vacuum vapor deposition apparatus was set to 400 °C and a wall heater was set to 180 °C. After the lapse of 15 minutes or more from the time when the base material temperature reached 400±2 °C, and before the start of a film formation process for a layer containing cerium oxide, the total value of the partial pressure of water molecules and the partial pressure of oxygen molecules was recognized to be 2.87×10⁻⁴ Pa. After that, a layer containing cerium oxide was formed on each of various kinds of base materials through use of CeO₂ as a film forming material. Subsequently, a Y₂O₃ film was formed thereon through use of Y₂O₃ as a film forming material to produce a multilayer film. The total value of the partial pressure of water molecules and the partial pressure of oxygen species during the film formation of 8 nm on the surface layer side of the layer containing cerium oxide (region (B)) was 5.84×10⁻³ Pa on average. Other film forming conditions are as described in the section (Production of Multilayer Film). The film was unsuitable as an optical member because the film had a refractive index larger than that of a Y₂O₃ film.

### (Evaluation of Oxygen Deficiency Rate)

A test piece of the resultant multilayer film was introduced into an X-ray photoelectron spectrometer (ESCA-300, manufactured by Scienta), and the apparatus was evacuated until a high vacuum was reached. A thin film above the layer 13 containing cerium oxide of the multilayer film was removed by etching with argon ions. Subsequently, the measurement of the XPS spectrum of a Ce 3d orbital and the etching with argon ions were repeated. Analysis was performed at a total of 3 points by changing the analysis area of the multilayer film. From the obtained results, the oxygen deficiency rate (V_{A}), oxygen deficiency rate (V_{B}), and oxygen deficiency rate (V_{C}) of the layer 13 containing cerium oxide were calculated.

Regarding the oxygen deficiency rate below the lower limit of quantification of X-ray photoelectron spectroscopy, observation, projection, and the measurement of an oxygen vacancy were performed with a scanning transmission electron microscope (HF5000, manufactured by Hitachi High-Technologies Corporation). As the pretreatment of the multilayer film to be measured, a measurement site was collected and micro-machined by any one, or a combination, of the following operations (1) to (3): (1) splitting the resultant multilayer film of a sample together with a base material and cutting the sample to expose its cross section; (2) processing with a focused ion beam (FIB); and (3) etching in a vertical direction with an ion beam. In addition, in order to minimize a change in oxygen vacancy, the processing was performed immediately after film formation in an atmosphere combining a low temperature, an argon gas, and a vacuum pump.

After that, a HAADF-STEM image and an ABF-STEM image each showing the presence or absence of an oxygen atom in the layer containing cerium oxide were obtained stepwise in the depth direction of a thickness under the condition of an accelerating voltage of 200 kV. In order to assist the observation of oxygen, which was a light element, and an oxygen vacancy, a LAADF-STEM image of the same area was also obtained. A total of five images were obtained by changing the analysis area of the multilayer film. Each of the obtained images was subjected to software processing to be converted into a mapping image, and the number of oxygen sites and the number of oxygen vacancies were counted, followed by the determination of the oxygen deficiency rates (V_{A}), (V_{B}), and (V_{C}) of the layer containing cerium oxide.

In each of the multilayer films obtained in Examples 19 to 22, 28, 38, and 39, and Comparative Examples 5 to 9, the oxygen deficiency rate (V_{A}) was also measured by an X-ray absorption fine structure method (XAFS). The measurement was performed by a fluorescence yield method using CeO₂ and Ce(NO₃)₃-6H₂O as standard samples, a Ce-L₃ absorption edge (5,723.0 eV) as a measurement absorption edge, and a multi-element silicon drift detector as a detector. The oxygen deficiency rate was calculated from the fitting result of the obtained XANES spectrum. There was almost no difference from the oxygen deficiency rate values measured by the X-ray photoelectron spectroscopy and with the electron microscope, and hence it was recognized that the measurement of the oxygen deficiency rate was appropriate.

### (Measurement of Thickness and Refractive Index)

The thickness and refractive index of each of the layer of the multilayer films of Examples and Comparative Examples were determined by using spectroscopic ellipsometry (ESM300, manufactured by J.A. Woollam Co.). The wavelength of a light source was set to from 192 nm to 1,000 nm, and measurement was performed at an incident angle in the range of from 450 to 650 in increments of 5°. In addition, in order to improve the accuracy of analysis, a transmittance was also measured. The obtained reflection and transmittance data were analyzed by combining models, such as Cauchy, Gaussian, Tauc-Lorentz, and effective medium approximation (surface roughness), to determine a thickness and a refractive index. The film is a multilayer film, and hence the number of layers and the thickness are complicated, and analysis may be difficult. In that case, a monolayer film separately obtained in the film formation of the same batch was subjected to measurement and analysis, and the analysis was performed through use of data such as the obtained refractive index.

### (Measurement of Composition)

The composition of the layer formed of two components, such as SiO₂+CeO₂ or SiO₂+Al₂O₃, in each of the multilayer films of Examples and Comparative Examples was determined by measurement with a wavelength-dispersive fluorescence X-ray spectroscopic analyzer (ZSX Primus II, manufactured by Rigaku Corporation). When quantitative analysis for each layer was difficult, a monolayer film separately obtained in the film formation of the same batch was subjected to measurement.

### (Identification of Structure)

Regarding the multilayer film formed on the Si substrate, the backscattered electron image and secondary electron image of its cross section were observed with an ultra-high resolution field emission scanning electron microscope (JSM-IT800, manufactured by JEOL Ltd.). From the obtained images, it was identified whether the multilayer film was a columnar structure or another structure (non-columnar). In this case, the thickness of each layer was also determined. There was almost no difference from the thickness value obtained with the ellipsometer, and hence it was recognized that the thickness measurement with the ellipsometer was appropriate. In addition, the composition of each layer was measured by energy-dispersive X-ray spectroscopy (EDX). There was almost no difference from the value obtained in the above-mentioned section (Measurement of Composition), and hence it was recognized that the above-mentioned measurement of the composition was appropriate.

### (Measurement of Crystallinity)

Each of the multilayer films of Examples and Comparative Examples was subjected to measurement in the range of 20=20° to 1000 with an XRD diffraction device (Smart Lab, manufactured by Rigaku Corporation) in a step of 0.010 and at a speed of 5°/min by a focusing method, and layers were identified and crystallinity was determined based on a diffraction line intensity or the like. The film is a multilayer film, and hence the diffraction intensity of MgF₂, SiO₂+CeO₂, or the like may hinder analysis. In that case, a monolayer film separately obtained in the film formation of the same batch was also subjected to measurement and analysis together. A multilayer film having a diffraction peak derived from a layer containing cerium oxide was determined to be crystalline, and a multilayer film having no diffraction peak derived from a layer containing cerium oxide was determined to be amorphous.

### (Evaluation of Hydrophilicity Maintenance)

Each of the multilayer films of Examples and Comparative Examples was left in the dark (temperature: 23±2 °C, humidity: 60±15% RH) for 60 days, and then, its contact angle with water was measured. After the measurement, the base material of the multilayer film was further left in the dark for 240 days. After the multilayer film had been left in the dark for a total of 300 days, its contact angle with water was measured. A model CA-X150 manufactured by Kyowa Interface Science Co., Ltd. was used as a contact angle meter. 2.5 mL of pure water was dropped onto a test piece from a microsyringe, and the contact angle 5 seconds after the dropping was determined by a θ/2 method.

The hydrophilicity of a surface may be quantified by the contact angle with water. In general, a case in which the contact angle is less than 200 is referred to as “hydrophilic”, and a case in which the contact angle is less than 100 is referred to as “superhydrophilic”. Following this, a case in which the contact angle was less than 100 was evaluated as [A], a case in which the contact angle was 100 or more and less than 200 was evaluated as [B], and a case in which the contact angle was 200 or more was evaluated as [C].

### (Evaluation of Self-Cleaning Performance)

Stearic acid was applied to each of the multilayer films of Examples and Comparative Examples through use of a heptane solution of stearic acid (0.3 mass %) in conformity with JIS R1753-1, and was dried in a dryer at 70 °C for 30 minutes. After that, the contact angle of the test piece having stearic acid applied thereto was measured by the same method as that described in the section (Evaluation of Hydrophilicity Maintenance), and it was recognized that the contact angle was 200 or more. When the contact angle was not 200 or more, the application of stearic acid, the drying, and the contact angle measurement were repeated until the contact angle became 200 or more. After that, the multilayer film having stearic acid applied thereto was irradiated with ultraviolet light for 2 hours and 30 hours, and then the contact angle was measured again, followed by the determination of a water contact angle after the irradiation with ultraviolet light. A black light blue fluorescent lamp (FL20SBL-B, manufactured by Hotalux, Ltd.) was used as an ultraviolet light source. The test piece was irradiated with ultraviolet light at an illuminance of 2.0 mw/cm².

In the same manner as in the above-mentioned evaluation in the section (Evaluation of Hydrophilicity Maintenance), a case in which the contact angle was less than 10° was evaluated as [A], a case in which the contact angle was 10° or more and less than 20° was evaluated as [B], and a case in which the contact angle was 20° or more was evaluated as [C].

The results obtained in the sections (Evaluation of Hydrophilicity Maintenance) and (Evaluation of Self-cleaning Performance) are shown in Table 1-1 to Table 1-8. In each of Examples and Comparative Examples, the evaluation results were the same regardless of the kind of the base material.

### (Evaluation of Optical Properties)

The transmittance and reflectance of each of the multilayer films of Examples and Comparative Examples at an incident angle of 5° were measured. An ultraviolet-visible-near-infrared spectrophotometer (UH4150, manufactured by Hitachi High-Tech Corporation) was used as a measuring device, and measurement was performed in the measurement wavelength range of from 450 nm to 1,200 nm in increments of 1 nm. Average values of the resultant transmittances (%) and reflectances (%) at the respective wavelengths were determined to provide an average transmittance (%) and an average reflectance (%). An average value of optical losses was determined by subtracting the average transmittance (%) and the average reflectance (%) from 100%. A case in which the average value of optical losses was less than 1% was evaluated as [A], and a case in which the average value was 1% or more was evaluated as [C].

TABLE 1-1

| | Base | | | | |
|---|---|---|---|---|---|
| | material | | | | |
| | temper- | | | | |
| | ature | Layer containing cerium oxide | | | |
| | during | Oxygen | Oxygen | Oxygen | |
| | vapor | defi- | defi- | defi- | |
| | depo- | ciency | ciency | ciency | |
| | sition | rate | rate | rate | |
| | [°C] | (V_{A}) [%] | (V_{B}) [%] | (V_{C}) [%] | Crystallinity |
| Example 1 | 400 | 0.05 | 0.50 | 0.04 | Crystalline |
| Example 2 | 400 | 0.09 | 0.50 | 0.08 | Crystalline |
| Example 3 | 400 | 0.11 | 2.70 | 0.03 | Crystalline |
| Example 4 | 400 | 0.14 | 3.30 | 0.04 | Crystalline |
| Example 5 | 400 | 0.19 | 4.00 | 0.07 | Crystalline |
| Example 6 | 400 | 0.23 | 3.90 | 0.11 | Crystalline |
| Example 7 | 400 | 0.27 | 4.10 | 0.15 | Crystalline |
| Example 8 | 400 | 0.30 | 3.70 | 0.19 | Crystalline |
| Example 9 | 400 | 0.34 | 3.70 | 0.23 | Crystalline |
| Example 10 | 400 | 0.49 | 2.40 | 0.43 | Crystalline |
| Example 11 | 400 | 0.55 | 2.70 | 0.48 | Crystalline |
| Example 12 | 400 | 0.59 | 2.90 | 0.52 | Crystalline |
| Example 13 | 400 | 0.68 | 3.40 | 0.59 | Crystalline |
| Example 14 | 400 | 0.72 | 2.20 | 0.67 | Crystalline |
| Example 15 | 400 | 0.97 | 2.90 | 0.91 | Crystalline |
| Example 16 | 400 | 1.11 | 3.30 | 1.04 | Crystalline |
| Example 17 | 400 | 2.34 | 7.20 | 2.19 | Crystalline |
| Example 18 | 400 | 3.20 | 9.60 | 2.99 | Crystalline |
| Example 19 | 400 | 4.90 | 14.70 | 4.57 | Crystalline |
| Example 20 | 400 | 6.20 | 18.60 | 5.80 | Crystalline |
| Example 21 | 400 | 8.87 | 26.60 | 8.26 | Crystalline |
| Example 22 | 400 | 9.94 | 29.80 | 9.30 | Crystalline |
| Example 23 | 250 | 0.06 | 0 | 0.07 | Crystalline |
| Example 24 | 350 | 0.15 | 0.04 | 0.16 | Crystalline |
| Example 25 | 300 | 0.29 | 0.08 | 0.30 | Crystalline |
| Example 26 | 300 | 0.50 | 0.09 | 0.51 | Crystalline |
| Example 27 | 400 | 3.35 | 33.50 | 2.84 | Crystalline |
| Example 28 | 400 | 8.00 | 32.00 | 7.58 | Crystalline |
| Example 29 | 400 | 0.05 | 0.51 | 0.05 | Crystalline |
| Example 30 | 400 | 0.06 | 0.62 | 0.05 | Crystalline |
| Example 31 | 400 | 0.11 | 4.30 | 0.04 | Crystalline |
| Example 32 | 400 | 0.23 | 4.00 | 0.15 | Crystalline |
| Example 33 | 400 | 0.28 | 9.00 | 0.18 | Crystalline |
| Example 34 | 400 | 0.40 | 6.40 | 0 | Crystalline |
| Example 35 | 400 | 0.55 | 29.00 | 0.10 | Crystalline |
| Example 36 | 400 | 0.56 | 2.00 | 0.52 | Crystalline |
| Example 37 | 400 | 0.80 | 3.67 | 0.71 | Crystalline |
| Example 38 | 400 | 5.00 | 7.40 | 4.93 | Crystalline |
| Example 39 | 400 | 9.00 | 28.30 | 8.41 | Crystalline |
| Example 40 | 400 | 0.94 | 29.80 | 0.05 | Crystalline |
| Example 41 | 400 | 0.05 | 0.60 | 0 | Crystalline |
| Example 42 | 400 | 0.58 | 1.90 | 0.42 | Crystalline |

TABLE 1-2

| | Layer containing cerium oxide | | | |
|---|---|---|---|---|
| | | | | H₂O + oxygen species |
| | | | H₂O + O₂ partial pressure | partial pressure during |
| | | Thickness | before film formation | film formation |
| | Structure | [nm] | [Pa] | [Pa] |
| Example 1 | Columnar | 255 | 1.53 × 10⁻⁴ | 3.11 × 10⁻³ |
| Example 2 | Columnar | 254 | 1.50 × 10⁻⁴ | 3.06 × 10⁻³ |
| Example 3 | Columnar | 272 | 1.50 × 10⁻⁴ | 3.05 × 10⁻³ |
| Example 4 | Columnar | 260 | 1.49 × 10⁻⁴ | 3.03 × 10⁻³ |
| Example 5 | Columnar | 252 | 1.48 × 10⁻⁴ | 3.00 × 10⁻³ |
| Example 6 | Columnar | 249 | 1.47 × 10⁻⁴ | 2.98 × 10⁻³ |
| Example 7 | Columnar | 260 | 1.45 × 10⁻⁴ | 2.96 × 10⁻³ |
| Example 8 | Columnar | 256 | 1.45 × 10⁻⁴ | 2.94 × 10⁻³ |
| Example 9 | Columnar | 255 | 1.44 × 10⁻⁴ | 2.92 × 10⁻³ |
| Example 10 | Columnar | 256 | 1.39 × 10⁻⁴ | 2.84 × 10⁻³ |
| Example 11 | Columnar | 254 | 1.38 × 10⁻⁴ | 2.80 × 10⁻³ |
| Example 12 | Columnar | 256 | 1.37 × 10⁻⁴ | 2.78 × 10⁻³ |
| Example 13 | Columnar | 257 | 1.34 × 10⁻⁴ | 2.73 × 10⁻³ |
| Example 14 | Columnar | 256 | 1.33 × 10⁻⁴ | 2.71 × 10⁻³ |
| Example 15 | Columnar | 258 | 1.26 × 10⁻⁴ | 2.57 × 10⁻³ |
| Example 16 | Columnar | 256 | 1.71 × 10⁻⁴ | 4.89 × 10⁻³ |
| Example 17 | Columnar | 259 | 1.78 × 10⁻⁴ | 7.23 × 10⁻³ |
| Example 18 | Columnar | 256 | 1.96 × 10⁻⁴ | 1.20 × 10⁻² |
| Example 19 | Columnar | 248 | 2.87 × 10⁻⁴ | 5.84 × 10⁻³ |
| Example 20 | Columnar | 256 | 2.83 × 10⁻⁴ | 5.76 × 10⁻³ |
| Example 21 | Columnar | 239 | 1.03 × 10⁻⁴ | 2.71 × 10⁻³ |
| Example 22 | Columnar | 257 | 2.83 × 10⁻⁴ | 5.76 × 10⁻³ |
| Example 23 | Columnar | 86 | 1.51 × 10⁻⁴ | 3.08 × 10⁻³ |
| Example 24 | Columnar | 128 | 1.49 × 10⁻⁴ | 3.03 × 10⁻³ |
| Example 25 | Columnar | 256 | 1.45 × 10⁻⁴ | 2.95 × 10⁻³ |
| Example 26 | Columnar | 482 | 1.39 × 10⁻⁴ | 2.83 × 10⁻³ |
| Example 27 | Columnar | 477 | 2.45 × 10⁻⁴ | 1.99 × 10⁻² |
| Example 28 | Columnar | 469 | 2.87 × 10⁻⁴ | 5.84 × 10⁻³ |
| Example 29 | Columnar | 762 | 1.51 × 10⁻⁴ | 3.08 × 10⁻³ |
| Example 30 | Columnar | 333 | 1.51 × 10⁻⁴ | 3.08 × 10⁻³ |
| Example 31 | Columnar | 511 | 1.50 × 10⁻⁴ | 3.05 × 10⁻³ |
| Example 32 | Columnar | 400 | 1.47 × 10⁻⁴ | 2.98 × 10⁻³ |
| Example 33 | Columnar | 722 | 1.45 × 10⁻⁴ | 2.95 × 10⁻³ |
| Example 34 | Columnar | 128 | 1.42 × 10⁻⁴ | 2.89 × 10⁻³ |
| Example 35 | Columnar | 511 | 1.38 × 10⁻⁴ | 2.80 × 10⁻³ |
| Example 36 | Columnar | 269 | 1.37 × 10⁻⁴ | 2.80 × 10⁻³ |
| Example 37 | Columnar | 269 | 1.31 × 10⁻⁴ | 2.66 × 10⁻³ |
| Example 38 | Columnar | 270 | 9.84 × 10⁻⁵ | 2.80 × 10⁻³ |
| Example 39 | Columnar | 270 | 2.87 × 10⁻⁴ | 5.84 × 10⁻³ |
| Example 40 | Columnar | 266 | 1.27 × 10⁻⁴ | 2.59 × 10⁻³ |
| Example 41 | Columnar | 85 | 1.51 × 10⁻⁴ | 3.08 × 10⁻³ |
| Example 42 | Columnar | 86 | 1.37 × 10⁻⁴ | 2.79 × 10⁻³ |

TABLE 1-3

| | | | | Evaluation of | |
|---|---|---|---|---|---|
| | | | | hydrophilicity-maintaining | |
| | Low-refractive-index layer | | | performance | |
| | | Refractive | | Contact angle | |
| | | index | Thickness | (60 days) | |
| | Composition | [—] | [nm] | [°] | Evaluation |
| Example 1 | MgF₂ | 1.38 | 99 | 5.6 | A |
| Example 2 | SiO₂ | 1.46 | 102 | 5.6 | A |
| Example 3 | SiO₂ + Al₂O₃ (2.5%) | 1.49 | 111 | 4.8 | A |
| Example 4 | MgF₂ | 1.38 | 99 | 5.0 | A |
| Example 5 | SiO₂ | 1.46 | 101 | 5.0 | A |
| Example 6 | SiO₂ + CeO₂ (5%) | 1.52 | 104 | 5.0 | A |
| Example 7 | MgF₂ | 1.38 | 99 | 5.0 | A |
| Example 8 | SiO₂ | 1.46 | 103 | 5.0 | A |
| Example 9 | SiO₂ + Al₂O₃ (2.5%) | 1.49 | 104 | 5.6 | A |
| Example 10 | MgF₂ | 1.38 | 97 | 5.6 | A |
| Example 11 | SiO₂ | 1.46 | 102 | 5.6 | A |
| Example 12 | SiO₂ + CeO₂ (5%) | 1.52 | 107 | 5.5 | A |
| Example 13 | MgF₂ | 1.38 | 98 | 6.3 | A |
| Example 14 | SiO₂ | 1.46 | 103 | 6.2 | A |
| Example 15 | SiO₂ + Al₂O₃ (2.5%) | 1.49 | 106 | 6.1 | A |
| Example 16 | MgF₂ | 1.38 | 97 | 6.3 | A |
| Example 17 | SiO₂ | 1.46 | 104 | 6.2 | A |
| Example 18 | SiO₂ + CeO₂ (5%) | 1.52 | 107 | 6.1 | A |
| Example 19 | MgF₂ | 1.38 | 94 | 6.3 | A |
| Example 20 | SiO₂ | 1.46 | 103 | 6.2 | A |
| Example 21 | SiO₂ + Al₂O₃ (2.5%) | 1.49 | 98 | 6.3 | A |
| Example 22 | SiO₂ | 1.46 | 103 | 6.2 | A |
| Example 23 | MgF₂ | 1.38 | 55 | 13.1 | B |
| Example 24 | SiO₂ | 1.46 | 103 | 9.9 | A |
| Example 25 | SiO₂ + Al₂O₃ (2.5%) | 1.49 | 105 | 8.6 | A |
| Example 26 | SiO₂ | 1.46 | 97 | 8.4 | A |
| Example 27 | MgF₂ | 1.38 | 91 | 9.2 | A |
| Example 28 | SiO₂ | 1.46 | 94 | 9.1 | A |
| Example 29 | MgF₂ | 1.38 | 145 | 4.3 | A |
| Example 30 | SiO₂ | 1.46 | 134 | 5.0 | A |
| Example 31 | SiO₂ + Al₂O₃ (2.5%) | 1.49 | 209 | 3.8 | A |
| Example 32 | MgF₂ | 1.38 | 152 | 4.2 | A |
| Example 33 | SiO₂ | 1.46 | 145 | 3.9 | A |
| Example 34 | SiO₂ + CeO₂ (5%) | 1.52 | 107 | 6.3 | A |
| Example 35 | MgF₂ | 1.38 | 97 | 5.0 | A |
| Example 36 | SiO₂ | 1.46 | 108 | 5.5 | A |
| Example 37 | SiO₂ + Al₂O₃ (2.5%) | 1.49 | 110 | 6.0 | A |
| Example 38 | MgF₂ | 1.38 | 102 | 6.1 | A |
| Example 39 | SiO₂ | 1.46 | 108 | 6.1 | A |
| Example 40 | SiO₂ + CeO₂ (5%) | 1.52 | 111 | 6.0 | A |
| Example 41 | SiO₂ | 1.46 | 57 | 8.1 | A |
| Example 42 | SiO₂ + CeO₂ (5%) | 1.52 | 60 | 8.0 | A |

TABLE 1-4

| | Evaluation of | | | | | | |
|---|---|---|---|---|---|---|---|
| | hydrophilicity- | | | | | | |
| | maintaining | | Evaluation of self-cleaning | | | | |
| | performance | | performance | | | | |
| | Contact angle (300 | | Contact angle (2 | | Contact angle (30 | | |
| | days) | | hours) | | hours) | | Optical |
| | [°] | Evaluation | [°] | Evaluation | [°] | Evaluation | characteristics |
| Example 1 | 6.5 | A | 9.0 | A | 5.2 | A | A |
| Example 2 | 6.5 | A | 9.0 | A | 5.3 | A | A |
| Example 3 | 4.8 | A | 8.1 | A | 4.7 | A | A |
| Example 4 | 5.0 | A | 7.9 | A | 4.6 | A | A |
| Example 5 | 5.0 | A | 8.0 | A | 4.7 | A | A |
| Example 6 | 5.0 | A | 8.1 | A | 4.7 | A | A |
| Example 7 | 5.0 | A | 7.9 | A | 4.6 | A | A |
| Example 8 | 5.0 | A | 8.0 | A | 4.7 | A | A |
| Example 9 | 6.5 | A | 9.1 | A | 5.3 | A | A |
| Example 10 | 6.5 | A | 8.9 | A | 5.2 | A | A |
| Example 11 | 6.5 | A | 9.0 | A | 5.3 | A | A |
| Example 12 | 6.4 | A | 9.1 | A | 5.3 | A | A |
| Example 13 | 7.7 | A | 9.9 | A | 5.8 | A | A |
| Example 14 | 7.6 | A | 10.0 | B | 5.8 | A | A |
| Example 15 | 7.6 | A | 10.1 | B | 5.9 | A | A |
| Example 16 | 7.7 | A | 9.9 | A | 5.8 | A | A |
| Example 17 | 7.6 | A | 10.0 | B | 5.9 | A | A |
| Example 18 | 7.6 | A | 10.1 | B | 5.9 | A | A |
| Example 19 | 7.8 | A | 9.9 | A | 5.8 | A | A |
| Example 20 | 7.6 | A | 10.0 | B | 5.8 | A | A |
| Example 21 | 7.8 | A | 10.0 | B | 5.9 | A | A |
| Example 22 | 7.6 | A | 10.0 | B | 5.8 | A | A |
| Example 23 | 16.0 | B | 16.1 | B | 9.6 | A | A |
| Example 24 | 12.4 | B | 16.0 | B | 9.4 | A | A |
| Example 25 | 11.2 | B | 14.1 | B | 8.2 | A | A |
| Example 26 | 11.2 | B | 13.3 | B | 7.8 | A | A |
| Example 27 | 12.0 | B | 14.0 | B | 8.2 | A | A |
| Example 28 | 12.0 | B | 14.2 | B | 8.3 | A | A |
| Example 29 | 5.2 | A | 8.1 | A | 4.7 | A | A |
| Example 30 | 5.9 | A | 9.1 | A | 5.3 | A | A |
| Example 31 | 3.8 | A | 8.2 | A | 4.8 | A | A |
| Example 32 | 4.2 | A | 8.0 | A | 4.7 | A | A |
| Example 33 | 3.9 | A | 7.3 | A | 4.2 | A | A |
| Example 34 | 7.2 | A | 10.4 | B | 6.1 | A | A |
| Example 35 | 5.9 | A | 7.9 | A | 4.6 | A | A |
| Example 36 | 6.4 | A | 9.0 | A | 5.3 | A | A |
| Example 37 | 7.5 | A | 10.1 | B | 5.9 | A | A |
| Example 38 | 7.6 | A | 9.9 | A | 5.8 | A | A |
| Example 39 | 7.5 | A | 10.0 | B | 5.9 | A | A |
| Example 40 | 7.5 | A | 10.1 | B | 5.9 | A | A |
| Example 41 | 9.1 | A | 9.8 | B | 5.8 | A | A |
| Example 42 | 8.9 | A | 9.9 | B | 5.9 | A | A |

TABLE 1-5

| | Base | | | | |
|---|---|---|---|---|---|
| | material | | | | |
| | temperature | Layer containing cerium oxide | | | |
| | during | Oxygen | Oxygen | Oxygen | |
| | vapor | deficiency | deficiency | deficiency | |
| | deposition | rate | rate | rate | |
| | [°C] | (V_{A}) [%] | (V_{B}) [%] | (V_{C}) [%] | Crystallinity |
| Example 43 | 400 | 0.06 | 0.60 | 0.03 | Crystalline |
| Example 44 | 400 | 0.30 | 2.60 | 0.14 | Crystalline |
| Example 45 | 400 | 0.06 | 0.50 | 0.05 | Crystalline |
| Example 46 | 400 | 0.28 | 2.20 | 0.24 | Crystalline |
| Example 47 | 400 | 0.08 | 0.60 | 0.07 | Crystalline |
| Example 48 | 400 | 0.44 | 4.00 | 0.38 | Crystalline |
| Example 49 | 400 | 0.07 | 4.50 | 0.01 | Crystalline |
| Example 50 | 400 | 0.59 | 5.00 | 0.53 | Crystalline |
| Example 51 | 400 | 0.05 | 5.50 | 0 | Crystalline |
| Example 52 | 400 | 0.28 | 6.00 | 0.22 | Crystalline |
| Example 53 | 400 | 0.11 | 13.20 | 0.00 | Crystalline |
| Example 54 | 400 | 0.31 | 13.30 | 0.12 | Crystalline |
| Example 55 | 400 | 0.58 | 9.00 | 0 | Crystalline |
| Example 56 | 400 | 1.11 | 8.00 | 1.02 | Crystalline |
| Example 57 | 400 | 4.32 | 9.60 | 4.27 | Crystalline |
| Example 58 | 400 | 6.00 | 19.20 | 5.60 | Crystalline |
| Example 59 | 28 | 1.13 | 6.00 | 1.02 | Crystalline |
| Example 60 | 31 | 0.28 | 10.00 | 0.07 | Crystalline |
| Example 61 | 100 | 2.10 | 10.50 | 1.91 | Crystalline |
| Example 62 | 100 | 0.60 | 11.00 | 0.37 | Crystalline |
| Example 63 | 270 | 5.21 | 22.50 | 4.83 | Crystalline |
| Example 64 | 270 | 2.22 | 23.00 | 1.76 | Crystalline |
| Example 65 | 500 | 0.58 | 23.50 | 0.07 | Crystalline |
| Example 66 | 500 | 8.84 | 24.00 | 8.50 | Crystalline |
| Comparative Example 1 | 300 | 0 | 0.03 | 0 | Crystalline |
| Comparative Example 2 | 400 | 0 | 0.10 | 0 | Crystalline |
| Comparative Example 3 | 400 | 0.01 | 0.20 | 0 | Crystalline |
| Comparative Example 4 | 400 | 0 | 0.20 | 0 | Crystalline |
| Comparative Example 5 | 400 | 10.60 | 10.10 | 10.61 | Crystalline |
| Comparative Example 6 | 400 | 10.31 | 0.20 | 10.44 | Crystalline |
| Comparative Example 7 | 400 | 11.11 | 0.20 | 11.23 | Crystalline |
| Comparative Example 8 | 400 | 10.70 | 0.20 | 11.40 | Crystalline |
| Comparative Example 9 | 400 | 15.00 | 0.20 | 15.48 | Crystalline |
| Comparative Example 10 | 400 | 0 | 0.20 | 0 | Crystalline |
| Comparative Example 11 | 250 | 0.04 | 0.20 | 0.03 | Crystalline |
| Comparative Example 12 | 250 | 0.03 | 0.20 | 0.02 | Crystalline |
| Comparative Example 13 | 600 | 0.06 | 0.50 | 0.03 | Crystalline |
| Comparative Example 14 | 600 | 0.07 | 3.00 | 0 | Crystalline |
| Comparative Example 15 | −18 | 4.72 | 13.93 | 4.41 | Amorphous |
| Comparative Example 16 | −18 | 6.02 | 18.11 | 5.63 | Amorphous |
| Comparative Example 17 | 400 | 0.15 | 0.04 | 0.16 | Crystalline |
| Comparative Example 18 | 400 | 4.75 | 47.50 | 3.37 | Crystalline |

TABLE 1-6

| | Layer containing cerium oxide | | | |
|---|---|---|---|---|
| | | | | H₂O + oxygen species |
| | | | H₂O + O₂ partial | partial pressure |
| | | | pressure before | during film |
| | | Thickness | film formation | formation |
| | Structure | [nm] | [Pa] | [Pa] |
| Example 43 | Columnar | 133 | 1.51 × 10⁻⁴ | 3.08 × 10⁻³ |
| Example 44 | Columnar | 121 | 1.45 × 10⁻⁴ | 2.94 × 10⁻³ |
| Example 45 | Columnar | 366 | 1.51 × 10⁻⁴ | 3.08 × 10⁻³ |
| Example 46 | Columnar | 372 | 1.45 × 10⁻⁴ | 2.95 × 10⁻³ |
| Example 47 | Columnar | 501 | 1.51 × 10⁻⁴ | 3.07 × 10⁻³ |
| Example 48 | Columnar | 496 | 1.41 × 10⁻⁴ | 2.87 × 10⁻³ |
| Example 49 | Columnar | 622 | 1.51 × 10⁻⁴ | 3.07 × 10⁻³ |
| Example 50 | Columnar | 630 | 1.37 × 10⁻⁴ | 2.78 × 10⁻³ |
| Example 51 | Columnar | 777 | 1.51 × 10⁻⁴ | 3.08 × 10⁻³ |
| Example 52 | Columnar | 798 | 1.45 × 10⁻⁴ | 2.95 × 10⁻³ |
| Example 53 | Columnar | 252 | 1.50 × 10⁻⁴ | 3.05 × 10⁻³ |
| Example 54 | Columnar | 541 | 1.44 × 10⁻⁴ | 2.94 × 10⁻³ |
| Example 55 | Columnar | 88 | 1.37 × 10⁻⁴ | 2.79 × 10⁻³ |
| Example 56 | Columnar | 594 | 1.22 × 10⁻⁴ | 2.49 × 10⁻³ |
| Example 57 | Columnar | 792 | 2.08 × 10⁻⁴ | 2.54 × 10⁻² |
| Example 58 | Columnar | 272 | 2.87 × 10⁻⁴ | 3.51 × 10⁻² |
| Example 59 | Columnar | 377 | 1.22 × 10⁻⁴ | 2.48 × 10⁻³ |
| Example 60 | Columnar | 377 | 1.45 × 10⁻⁴ | 2.95 × 10⁻³ |
| Example 61 | Columnar | 371 | 9.54 × 10⁻⁵ | 1.94 × 10⁻³ |
| Example 62 | Columnar | 372 | 1.36 × 10⁻⁴ | 2.78 × 10⁻³ |
| Example 63 | Columnar | 368 | 2.87 × 10⁻⁴ | 5.84 × 10⁻³ |
| Example 64 | Columnar | 369 | 1.84 × 10⁻⁴ | 7.50 × 10⁻³ |
| Example 65 | Columnar | 365 | 1.37 × 10⁻⁴ | 2.79 × 10⁻³ |
| Example 66 | Columnar | 366 | 2.87 × 10⁻⁴ | 8.18 × 10⁻³ |
| Comparative Example 1 | Columnar | 72 | 8.20 × 10⁻³ | 6.68 × 10⁻² |
| Comparative Example 2 | Columnar | 123 | 6.15 × 10⁻³ | 5.01 × 10⁻² |
| Comparative Example 3 | Columnar | 255 | 1.53 × 10⁻⁴ | 1.80 × 10⁻² |
| Comparative Example 4 | Columnar | 370 | 1.53 × 10⁻⁴ | 3.11 × 10⁻³ |
| Comparative Example 5 | Columnar | 492 | 2.91 × 10⁻⁴ | 1.07 × 10⁻² |
| Comparative Example 6 | Columnar | 615 | 2.87 × 10⁻⁴ | 1.17 × 10⁻² |
| Comparative Example 7 | Columnar | 744 | 2.83 × 10⁻⁴ | 1.27 × 10⁻² |
| Comparative Example 8 | Columnar | 128 | 2.79 × 10⁻⁴ | 1.36 × 10⁻² |
| Comparative Example 9 | Columnar | 256 | 2.75 × 10⁻⁴ | 1.57 × 10⁻² |
| Comparative Example 10 | Columnar | 372 | 1.53 × 10⁻⁴ | 5.00 × 10⁻² |
| Comparative Example 11 | Columnar | 126 | 1.52 × 10⁻⁴ | 3.09 × 10⁻² |
| Comparative Example 12 | Columnar | 259 | 1.52 × 10⁻⁴ | 3.02 × 10⁻² |
| Comparative Example 13 | Non-columnar | 128 | 1.51 × 10⁻⁴ | 3.08 × 10⁻³ |
| Comparative Example 14 | Non-columnar | 269 | 1.51 × 10⁻⁴ | 3.07 × 10⁻³ |
| Comparative Example 15 | Non-columnar | 248 | 2.38 × 10⁻⁵ | 4.84 × 10⁻⁴ |
| Comparative Example 16 | Non-columnar | 256 | 2.87 × 10⁻⁴ | 5.84 × 10⁻³ |
| Comparative Example 17 | Columnar | 128 | 1.49 × 10⁻⁴ | 3.03 × 10⁻³ |
| Comparative Example 18 | Columnar | 255 | 2.87 × 10⁻⁴ | 5.84 × 10⁻³ |

TABLE 1-7

| | | | | Evaluation of | |
|---|---|---|---|---|---|
| | | | | hydrophilicity- | |
| | | | | maintaining | |
| | Low-refractive-index layer | | | performance | |
| | | Refractive | | Contact angle (60 | |
| | | index | Thickness | days) | |
| | Composition | [—] | [nm] | [°] | Evaluation |
| Example 43 | MgF₂ | 1.38 | 101 | 6.3 | A |
| Example 44 | SiO₂ | 1.46 | 97 | 5.8 | A |
| Example 45 | SiO₂ + Al₂O₃ (2.5%) | 1.49 | 75 | 5.6 | A |
| Example 46 | MgF₂ | 1.38 | 71 | 5.1 | A |
| Example 47 | SiO₂ | 1.46 | 101 | 5.0 | A |
| Example 48 | SiO₂ + CeO₂ (5%) | 1.52 | 104 | 5.0 | A |
| Example 49 | MgF₂ | 1.38 | 118 | 4.7 | A |
| Example 50 | SiO₂ | 1.46 | 126 | 4.6 | A |
| Example 51 | SiO₂ + Al₂O₃ (2.5%) | 1.49 | 80 | 4.9 | A |
| Example 52 | MgF₂ | 1.38 | 76 | 4.4 | A |
| Example 53 | SiO₂ | 1.46 | 51 | 5.9 | A |
| Example 54 | SiO₂ + CeO₂ (5%) | 1.52 | 57 | 5.6 | A |
| Example 55 | MgF₂ | 1.38 | 55 | 8.0 | A |
| Example 56 | SiO₂ | 1.46 | 238 | 4.5 | A |
| Example 57 | SiO₂ + Al₂O₃ (2.5%) | 1.49 | 236 | 4.4 | A |
| Example 58 | MgF₂ | 1.38 | 52 | 7.2 | A |
| Example 59 | SiO₂ | 1.46 | 94 | 5.9 | A |
| Example 60 | SiO₂ + CeO₂ (5%) | 1.52 | 92 | 4.7 | A |
| Example 61 | MgF₂ | 1.38 | 92 | 5.9 | A |
| Example 62 | SiO₂ | 1.46 | 91 | 5.4 | A |
| Example 63 | SiO₂ + Al₂O₃ (2.5%) | 1.49 | 88 | 6.0 | A |
| Example 64 | MgF₂ | 1.38 | 89 | 6.0 | A |
| Example 65 | SiO₂ | 1.46 | 88 | 5.4 | A |
| Example 66 | SiO₂ + CeO₂ (5%) | 1.52 | 85 | 6.1 | A |
| Comparative Example 1 | SiO₂ | 1.46 | 91 | 26.4 | C |
| Comparative Example 2 | SiO₂ + CeO₂ (5%) | 1.52 | 92 | 23.4 | C |
| Comparative Example 3 | MgF₂ | 1.38 | 109 | 19.6 | B |
| Comparative Example 4 | SiO₂ | 1.46 | 121 | 17.9 | B |
| Comparative Example 5 | SiO₂ + Al₂O₃ (2.5%) | 1.49 | 111 | 17.4 | B |
| Comparative Example 6 | MgF₂ | 1.38 | 91 | 17.6 | B |
| Comparative Example 7 | SiO₂ | 1.46 | 89 | 17.1 | B |
| Comparative Example 8 | SiO₂ + CeO₂ (5%) | 1.52 | 88 | 23.4 | C |
| Comparative Example 9 | MgF₂ | 1.38 | 91 | 20.3 | C |
| Comparative Example 10 | SiO₂ | 1.46 | 91 | 19.1 | B |
| Comparative Example 11 | SiO₂ + Al₂O₃ (2.5%) | 1.49 | 90 | 23.4 | C |
| Comparative Example 12 | MgF₂ | 1.38 | 93 | 20.2 | C |
| Comparative Example 13 | SiO₂ + CeO₂ (5%) | 1.52 | 50 | 22.6 | C |
| Comparative Example 14 | SiO₂ | 1.46 | 98 | 16.7 | B |
| Comparative Example 15 | MgF₂ | 1.38 | 94 | 50.2 | C |
| Comparative Example 16 | SiO₂ | 1.46 | 103 | 48.9 | C |
| Comparative Example 17 | SiO | 1.79 | 103 | 9.9 | A |
| Comparative Example 18 | Y₂O₃ | 1.86 | 98 | 10.0 | B |

TABLE 1-8

| | Evaluation of | | | | | | |
|---|---|---|---|---|---|---|---|
| | hydrophilicity- | | | | | | |
| | maintaining | | Evaluation of self-cleaning | | | | |
| | performance | | performance | | | | |
| | Contact angle (300 | | Contact angle | | Contact angle (30 | | |
| | days) | | (2 hours) | | hours) | | Optical |
| | [°] | Evaluation | [°] | Evaluation | [°] | Evaluation | characteristics |
| Example 43 | 7.2 | A | 10.2 | B | 5.9 | A | A |
| Example 44 | 5.8 | A | 9.2 | A | 5.3 | A | A |
| Example 45 | 6.5 | A | 7.9 | A | 4.6 | A | A |
| Example 46 | 5.1 | A | 6.9 | A | 4.0 | A | A |
| Example 47 | 5.9 | A | 8.0 | A | 4.7 | A | A |
| Example 48 | 5.9 | A | 8.1 | A | 4.7 | A | A |
| Example 49 | 5.6 | A | 8.0 | A | 4.7 | A | A |
| Example 50 | 5.5 | A | 8.1 | A | 4.7 | A | A |
| Example 51 | 5.8 | A | 7.1 | A | 4.1 | A | A |
| Example 52 | 4.4 | A | 6.2 | A | 3.6 | A | A |
| Example 53 | 5.9 | A | 6.8 | A | 4.0 | A | A |
| Example 54 | 6.5 | A | 6.9 | A | 4.0 | A | A |
| Example 55 | 9.0 | A | 10.0 | B | 5.8 | A | A |
| Example 56 | 6.0 | A | 10.3 | B | 6.0 | A | A |
| Example 57 | 5.8 | A | 9.8 | A | 5.7 | A | A |
| Example 58 | 8.6 | A | 8.4 | A | 4.9 | A | A |
| Example 59 | 7.3 | A | 9.2 | A | 5.4 | A | A |
| Example 60 | 4.7 | A | 7.3 | A | 4.3 | A | A |
| Example 61 | 7.4 | A | 9.2 | A | 5.4 | A | A |
| Example 62 | 6.3 | A | 8.2 | A | 4.8 | A | A |
| Example 63 | 7.4 | A | 9.1 | A | 5.3 | A | A |
| Example 64 | 7.4 | A | 9.1 | A | 5.3 | A | A |
| Example 65 | 6.3 | A | 8.2 | A | 4.8 | A | A |
| Example 66 | 7.5 | A | 9.0 | A | 5.3 | A | A |
| Comparative Example 1 | 30.6 | C | 40.5 | C | 23.6 | C | A |
| Comparative Example 2 | 27.6 | C | 36.1 | C | 21.0 | C | A |
| Comparative Example 3 | 23.8 | C | 32.5 | C | 19.0 | B | A |
| Comparative Example 4 | 22.1 | C | 31.1 | C | 18.2 | B | A |
| Comparative Example 5 | 21.6 | C | 29.2 | C | 17.0 | B | C |
| Comparative Example 6 | 21.8 | C | 27.0 | C | 15.7 | B | C |
| Comparative Example 7 | 21.3 | C | 26.1 | C | 15.2 | B | C |
| Comparative Example 8 | 27.6 | C | 35.4 | C | 20.7 | C | C |
| Comparative Example 9 | 24.5 | C | 31.2 | C | 18.2 | B | C |
| Comparative Example 10 | 23.3 | C | 29.3 | C | 17.1 | B | A |
| Comparative Example 11 | 27.6 | C | 35.7 | C | 20.8 | C | A |
| Comparative Example 12 | 24.4 | C | 31.3 | C | 18.3 | B | A |
| Comparative Example 13 | 26.5 | C | 26.1 | C | 15.2 | B | A |
| Comparative Example 14 | 20.6 | C | 26.6 | C | 15.5 | B | A |
| Comparative Example 15 | 55.7 | C | 78.1 | C | 45.6 | C | A |
| Comparative Example 16 | 54.5 | C | 79.2 | C | 46.2 | C | A |
| Comparative Example 17 | 12.4 | B | 16.0 | B | 9.4 | A | C |
| Comparative Example 18 | 12.9 | B | 15.9 | B | 9.3 | A | C |

### Comparative Example 23

A TiO2 film was formed instead of forming the layer containing cerium oxide in Example 23. In this case, Ti3O5 was used as a film forming material. Other film forming conditions were the same conditions as those in Example 23. Thus, a multilayer film was formed. The crystallinity of the TiO2 layer was evaluated to be an anatase-type polycrystal. In addition, the structure of the layer was evaluated to be a columnar structure. The hydrophilicity-maintaining performance of the multilayer film was evaluated as follows: a water contact angle after the lapse of 60 days was 58.7°; and a water contact angle after the lapse of 300 days was 63.4°. The self-cleaning performance of the multilayer film was evaluated as follows: a water contact angle after 2 hours of irradiation was 77.5°; and a water contact angle after 30 hours of irradiation was 72.5°.

### Comparative Example 24

A TiO₂ film was formed instead of forming the layer containing cerium oxide in Example 24. In this case, Ti₃O₅ was used as a film forming material. Other film forming conditions were the same conditions as those in Example 24. Thus, a multilayer film was formed. The crystallinity of the TiO₂ layer was evaluated as follows: the layer was a polycrystal, which contained an anatase-type crystal as a main component, and in which a trace amount of a rutile-type crystal was present in addition to the anatase-type crystal. In addition, the structure of the layer was evaluated to be a columnar structure. The hydrophilicity-maintaining performance of the multilayer film was evaluated as follows: a water contact angle after the lapse of 60 days was 39.4°; and a water contact angle after the lapse of 300 days was 61.6°. The self-cleaning performance of the multilayer film was evaluated as follows: a water contact angle after 2 hours of irradiation was 72.3°; and a water contact angle after 30 hours of irradiation was 63.4°.

### Comparative Example 25

Various kinds of base materials were set in a holder made of brass and a holder made of aluminum having a purity of 99.5%. Vacuum evacuation was performed up to 1.3×10⁻³ Pa or less while the substrate heating of a vacuum vapor deposition apparatus was set to OFF and a wall heater was set to OFF. A substrate temperature before film formation was 24 °C. A Cr layer (1 nm) was formed as a first layer on each of the various kinds of base materials. A layer containing cerium oxide was formed by using a hearth liner made of oxygen-free copper and CeO₂ as a film forming material. Before the start of a film formation process for the layer containing cerium oxide, the total value of the partial pressure of water molecules and the partial pressure of oxygen molecules was recognized to be 8.94×10⁻⁴ Pa. Subsequently, a SiO₂ film (low-refractive-index layer) was formed thereon through use of SiO₂ as a film forming material to produce a multilayer film. The total value of the partial pressure of water molecules and the partial pressure of oxygen species during the film formation of 8 nm on the surface layer side of the layer containing cerium oxide (region (B): a region of the layer containing cerium oxide positioned within 8 nm from an interface between the layer containing cerium oxide and a layer containing silicon oxide or a layer containing magnesium fluoride) was 8.03×10⁻³ Pa on average. The crystallinity, structure, optical characteristics, and oxygen deficiency rates of the resultant multilayer film were evaluated in the same manner as in each of the multilayer films of Examples 1 to 68. As a result of the evaluation, the layer containing cerium oxide had a crystalline columnar structure, and the oxygen deficiency rates were 0.02% for V_{A}, 0.01% for V_{B}, and 0.02% for V_{C}. The refractive index of the SiO₂ layer was 1.46. In addition, the optical loss of the multilayer film was 1.4%, and the optical characteristics were evaluated as [C].

### Example 67

A flat glass sheet including the multilayer film obtained in Example 3 was processed and mounted to the outside of the near-infrared sensor of a commercially available vehicle so as to serve as a protective cover for the sensor.

### Example 68

A dome-shaped transparent base material made of a polymethyl methacrylate resin (ACRYLITE (trademark), manufactured by Mitsubishi Chemical Corporation) having an acrylic hard coat formed thereon was used as a base material. Vacuum evacuation was performed while the base material temperature of a vacuum vapor deposition apparatus was set to 50 °C and a wall heater was set to 50 °C. After the lapse of 15 minutes or more from the time when the base material temperature reached 50±2 °C, and before the start of a film formation process for a layer containing cerium oxide, the total value of the partial pressure of water molecules and the partial pressure of oxygen molecules was recognized to be 1.49×10⁻⁴ Pa. A SiO₂ film (200 nm) was formed as a first layer at a vapor deposition rate of 0.3 nm/s through use of SiO as a film forming material.

Next, a Ta₂O₅ film (14 nm) was formed as a second layer at a vapor deposition rate of 0.2 nm/s through use of TaO as a film forming material. A SiO₂ film (35 nm) was formed as a third layer at a vapor deposition rate of 0.7 nm/s through use of SiO₂ as a film forming material. A layer containing cerium oxide (256 nm) was formed as a fourth layer at a vapor deposition rate of 0.3 nm/s through use of Ce and CeO₂ as film forming materials. A SiO₂ (95%)+CeO₂ (5%) film (79 nm, refractive index: 1.52) was formed as a fifth layer at a vapor deposition rate of 0.5 nm/s through use of SiO and CeO₂ as film forming materials. A SiO₂ film (10 nm, refractive index: 1.46) was formed as a final sixth layer through use of SiO₂ as a film forming material to produce a multilayer film. During the film formation, the multilayer film was produced while the base material was subjected to planetary rotation.

In addition, when the first, second, and fourth layers were formed, ion-assisted deposition was performed with an RF ion source. In this case, in the first layer, the ion-assisted deposition was performed under the conditions of an accelerating voltage value of 280 V, an accelerating current value of 280 mA, and an O₂ gas flow rate of 40 sccm, and in the second layer, the ion-assisted deposition was performed under the conditions of an accelerating voltage value of 500 V, an accelerating current value of 500 mA, and an O₂ gas flow rate of 60 sccm. In the fifth layer, ion-assisted deposition was performed under the conditions of an accelerating voltage value of 500 V, an accelerating current value of 500 mA, and an O₂ gas flow rate of 40 sccm. When 8 nm on the surface layer side of the fifth layer was formed, the film was formed by changing the film forming rate to 0.5 nm/s, and further changing the O₂ gas flow rate of the ion source to 0 sccm and the Ar gas flow rate thereof to 40 sccm.

Regarding the resultant dome-shaped resin base material with a multilayer film and various kinds of substrates subjected to the film formation at the same time, the composition, crystallinity, structure, oxygen deficiency rates, and optical characteristics of the thin film were evaluated in the same manner as in each of the multilayer films of Examples 1 to 68. As a result of the evaluation, the composition of the SiO₂+CeO₂ layer was SiO₂ (95%)+CeO₂ (5%), the thickness was 79 nm, and the refractive index was 1.52. The refractive index of the SiO₂ layer was 1.46. In addition, the layer containing cerium oxide had a crystalline columnar structure, the oxygen deficiency rates were 0.05% for V_{A}, 0.52% for V_{B}, and 0.03% for V_{C}, and an optical loss was less than 1.5%. Subsequently, the resultant dome-shaped resin base material with a multilayer film was mounted to a surveillance camera for use as a surveillance camera cover.

The surveillance camera having the produced cover mounted thereto was stored in a product packaging box that was a dark place for 4 months. After that, the surveillance camera was installed outdoors when it rained at night. Even when water adhered to the surveillance camera owing to rain, water droplets were wet-spread on the cover, and hence satisfactory visibility was maintained. In addition, even after the moisture was dried, no water marks remained, and hence satisfactory visibility was maintained. Further, even when it rained 8 months after the surveillance camera had been installed outdoors, water droplets were wet-spread on the cover, and hence satisfactory visibility was maintained.

### Example 69

A resin base material (MR-8, manufactured by Mitsui Chemicals, Inc.) having a silicon-based hard coat formed thereon was used as abase material. Vacuum evacuation was performed while the base material temperature of a vacuum vapor deposition apparatus was set to 80 °C and a wall heater was set to 80 °C. After the lapse of 15 minutes or more from the time when the base material temperature reached 80±2 °C, and before the start of a film formation process for a layer containing cerium oxide, the total value of the partial pressure of water molecules and the partial pressure of oxygen molecules was recognized to be 1.52×10⁻⁴ Pa. An Al₂O₃ film (82 nm) was formed as a first layer of a multilayer film through use of Al₂O₃ as a film forming material. A CeO₂ film (252 nm) was formed as a second layer through use of Ce and CeO₂ as film forming materials. A SiO₂ (95%)+CeO₂ (5%) film (75 nm, refractive index: 1.52) was formed as a third layer through use of SiO₂ and Al₂O₃ as film forming materials. A SiO₂ film (15 nm, refractive index: 1.46) was formed as a final fourth layer through use of SiO₂ as a film forming material to produce a multilayer film. During the film formation, the multilayer film was produced at a vapor deposition rate of 0.5 nm/s. The resultant resin base material with a multilayer film was processed and mounted to a frame for a pair of eyeglasses, to thereby produce a pair of eyeglasses.

Regarding the resultant eyeglass lens base material with a multilayer film and various kinds of substrates subjected to the film formation at the same time, crystallinity, structure, oxygen deficiency rates, and optical characteristics were evaluated in the same manner as in each of the multilayer films of Examples 1 to 68. As a result of the evaluation, the layer containing cerium oxide had a crystalline columnar structure, the oxygen deficiency rates were 0.05% for V_{A}, 0.53% for V_{B}, and 0.03% for V_{C}, and an optical loss was less than 1.5%. Subsequently, the pair of eyeglasses thus produced was stored in an eyeglass case made of aluminum, which was a dark place, for 3 months. After that, when water airborne droplets were allowed to adhere to a lens, the water droplets were wet-spread on the lens, and hence satisfactory visibility was maintained. The contact angle of water in this case was 4.7°. In addition, even after the moisture was dried, no water marks remained, and hence satisfactory visibility was maintained.

The multilayer film of the present disclosure may be used in, for example, optical members, such as an optical filter, an optical lens, a daylighting lens, an optical film, an optical prism, an eyeglass lens, a photographic lens, a vehicle door mirror, a glass sheet, a condenser lens, a display cover glass, a touch panel, and various kinds of films, or covers for protecting optical members, such as a surveillance camera cover, an in-vehicle camera cover, and an in-vehicle sensor cover.

In addition, the optical member of the present disclosure may be used in, for example, optical devices, such as a digital camera, a digital video camera, an action camera, an endoscope, a lens barrel, a pair of eyeglasses, a sensor, a pair of binoculars, a telescope, a surveillance camera, an in-vehicle camera, a smartphone, a tablet PC, a weather camera, a live camera, a pair of protective goggles, a pair of swimming goggles, a head-mounted display, a pair of sunglasses, a pair of smart glasses, a face shield, a helmet shield, a vehicle mirror, and a bathroom mirror, or covers for protecting the optical devices.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A multilayer film comprising:
a layer containing cerium oxide; and
a low-refractive-index layer formed on the layer containing cerium oxide directly or through intermediation of another layer,
wherein the low-refractive-index layer includes a layer containing silicon oxide or a layer containing magnesium fluoride,
wherein the layer containing cerium oxide contains cerium oxide having a cubic polycrystalline structure and a columnar structure,
wherein the layer containing cerium oxide has a thickness of 85 nm or more and 800 nm or less,
wherein, when an entirety of the layer containing cerium oxide is represented by a region (A) and an oxygen deficiency rate of cerium oxide in the region (A) is represented by an oxygen deficiency rate (V_{A}), the oxygen deficiency rate (V_{A}) is 0.05% or more and 10% or less,
wherein the low-refractive-index layer has a thickness of 50 nm or more and 240 nm or less, and
wherein the low-refractive-index layer has a refractive index of 1.65 or less with respect to light having a wavelength of 500 nm.

2. The multilayer film according to claim 1, wherein the oxygen deficiency rate (V_{A}) is 0.05% or more and 0.6% or less.

3. The multilayer film according to claim 1, wherein the oxygen deficiency rate (V_{A}) is 0.1% or more and 0.3% or less.

4. The multilayer film according to claim 1, wherein, when a region of the layer containing cerium oxide present in a range of 8 nm or less from an interface between the layer containing cerium oxide and the low-refractive-index layer is represented by a region (B), and an oxygen deficiency rate of cerium oxide in the region (B) is represented by an oxygen deficiency rate (V_{B}), the oxygen deficiency rate (V_{B}) is 0.5% or more and 30% or less.

5. The multilayer film according to claim 4,
wherein the oxygen deficiency rate (V_{A}) is 0.05% or more and 10% or less,
wherein the oxygen deficiency rate (V_{B}) is 0.5% or more and 30% or less,
wherein, when a region excluding the region (B) in the region (A) is represented by a region (C) and an oxygen deficiency rate of cerium oxide in the region (C) is represented by an oxygen deficiency rate (V_{C}), the oxygen deficiency rate (V_{C}) is 0% or more and 10% or less, and
wherein the oxygen deficiency rate (V_{B}) is larger than the oxygen deficiency rate (V_{C}).

6. An optical member comprising the multilayer film of claim 1.

7. A method of producing a multilayer film, the method comprising:
a step (A) of forming a layer containing cerium oxide on a base material directly or through intermediation of another layer by a vacuum vapor deposition method; and
a step (B) of forming a low-refractive-index layer on the layer containing cerium oxide directly or through intermediation of another layer by the vacuum vapor deposition method,
wherein the low-refractive-index layer includes a layer containing silicon oxide or a layer containing magnesium fluoride,
wherein the layer containing cerium oxide contains cerium oxide having a cubic polycrystalline structure and a columnar structure,
wherein the layer containing cerium oxide has a thickness of 85 nm or more and 800 nm or less,
wherein, when an entirety of the layer containing cerium oxide is represented by a region (A) and an oxygen deficiency rate of cerium oxide in the region (A) is represented by an oxygen deficiency rate (V_{A}), the oxygen deficiency rate (V_{A}) is 0.05% or more and 10% or less, and
wherein the low-refractive-index layer has a thickness of 50 nm or more and 240 nm or less.

8. The method of producing a multilayer film according to claim 7,
wherein, when a region of the layer containing cerium oxide present in a range of 8 nm or less from an interface between the layer containing cerium oxide and the low-refractive-index layer is represented by a region (B), and an oxygen deficiency rate of cerium oxide in the region (B) is represented by an oxygen deficiency rate (V_{B}), the oxygen deficiency rate (V_{B}) is 0.5% or more and 30% or less,
wherein, when a region excluding the region (B) in the region (A) is represented by a region (C) and an oxygen deficiency rate of cerium oxide in the region (C) is represented by an oxygen deficiency rate (V_{C}), the oxygen deficiency rate (V_{C}) is 0% or more and 10% or less, and
wherein the oxygen deficiency rate (V_{B}) is larger than the oxygen deficiency rate (V_{C}).

9. The method of producing a multilayer film according to claim 7,
wherein, prior to the step (A), a total value of a partial pressure of water molecules and a partial pressure of oxygen molecules in an atmosphere in advance is 2×10⁻² Pa or less, and
wherein a total value of a partial pressure of water molecules and a partial pressure of oxygen species during film formation of the region (B) is 2×10⁻² Pa or less on average.
